(19) United States
(12) Patent Application Publication
(10) Pub. No.: US 2012/0264048 A1
(43) Pub. Date: Oct. 18, 2012

(54) TONER, IMAGE FORMING METHOD, IMAGE FORMING APPARATUS, AND PROCESS CARTRIDGE

(76) Inventors: Yoshimichi ISHIKAWA, Hyogo (JP); Takuya KADOTA, Hyogo (JP); Yoshihiro MIKURIYA, Hyogo (JP); Tsuyoshi NOZAKI, Osaka (JP); Kazuoki FUWA, Hyogo (JP); Tomohiro FUKAO, Osaka (JP); Tomoharu MIKI, Osaka (JP); Atsushi YAMAMOTO, Shizuoka (JP)

(21) Appl. No.: 13/443,220

(22) Filed: Apr. 10, 2012

(30) Foreign Application Priority Data
Apr. 14, 2011 (JP) 2011-089902
Mar. 23, 2012 (JP) 2012-068172

(51) Int. Cl. G03G 13/20; G03G 9/087; G03G 21/18

(52) U.S. Cl. 430/124.1; 399/111; 430/109.3

(57) ABSTRACT

Provided is a toner including: toner particles, each toner particle containing a toner base particle, wherein the toner contains a binder resin; and a colorant, wherein the toner base particle has protrusions at a surface thereof, wherein an average of lengths of long sides of the protrusions is 0.1 μm or more but less than 0.5 μm, a standard deviation of the lengths of the long sides of the protrusions is 0.20 or less, and a coverage rate of the protrusions is 30% to 90%, wherein a resin forming the protrusions is prepared through polymerization of a monomer mixture containing at least a monomer having a sulfonic acid group, and wherein the monomer mixture contains styrene in an amount of 90% by mass or more and the monomer having a sulfonic acid group in an amount of 0.1% by mass to 5% by mass.

### BACKGROUND OF THE INVENTION

1. Field of the Invention

The present invention relates to a toner, a developer, and a process cartridge that are used for an electrophotographic image forming apparatus, as well as an image forming method.

2. Description of the Related Art

In recent years, printers have superior performances; particularly, full-color printers that are high-speed, have extended service life, and can produce high-quality images have been developed. With superior performances, there are increasing demands for certain performances of toners. Especially, high-speed printers demand charge rising property, stability, and anti-stress property of a toner. Many studies have been carried out to improve those properties.

For example, Japanese Patent Application Laid-Open (JP-A) Nos. 2006-503313, 2006-500605, and 2003-202708 all describe a layered compound used for controlling charge. However, the charge rising property of the toner is not sufficient to provide desirable properties for one-component developing. If an appropriate amount of the layered compound is used to achieve the rising property, charge stability to the environment is affected because the layered compound inherently has hydrophilic properties.

JP-A No. 01-235959 proposes a technique in which a fluorine compound is allowed to locate on the toner surface to thereby reduce adhesion force between a toner and a photoconductor. In this technique, toner particles are produced by a suspension polymerization method. This allows a hydrophilic group-containing fluorine compound that has surface active property to be located on the surfaces of the toner particles. This method, however, sometimes causes an issue as follows. When the amount of the fluorine compound present on the toner surface is adjusted in order to control adhesion force, there is a potential concern that the hydrophilic group of the fluorine compound adversely affects the toner. In addition, the fluorine compound is weakly bound to the toner base particles and it is not possible to prevent reduction in its effect after a long period of use. Therefore, when such technique is applied to a fluorine-containing charge controlling agent, it is difficult to keep the effect over the time and thus toner chargeability cannot be controlled in a sufficient range.

Further, JP-A No. 05-053367 proposes a method in which toner particles each include a surface layer containing polymers or copolymers of fluorinated alkyl acrylate or fluorinated alkyl methacrylate to thereby provide the toner with chargeability.

In order to achieve localization of a fluorine-containing resin on the surface of a toner particle, this method needs a coating step in which toner particles prepared separately are subjected to the treatment in the solvent that contains the fluorine-containing resin to coat the surfaces of the toner particles. This step leads to increased production cost. In addition, it is necessary to use a fluorine-containing resin that is dissolve in the solvent such as alcohol. The chargeability of the toner cannot be controlled in a sufficient range by such fluorine-containing resin.

Improvement of the anti-stress property of the toner has conventional been attempted through the resin design of the toner. General method is that the molecular weight distribution of the resin is adjusted by the combination of polymers with high molecular weight and polymers with low molecular weight to thereby balance the mechanical strength, blocking resistance, and fixability of the toner. Further, a design method, in which a toner is designed to have a core-shell structure, is widely known. The core-shell structure of the toner aims to separate functions. The core part is designed to improve the low-temperature fixing property and the shell part is designed to improve the mechanical strength and blocking resistance.

When a toner having a core-shell structure is produced, particles for the shell material are designed to have a high molecular weight or to have a molecular structure that includes e.g. a crosslinked structure. This design method allows attachment of the shell material to the core part, however, there is an issue that fusion and film formation do not proceed well and consequently toners are produced such that the capsule structure is easily destroyed.

### SUMMARY OF THE INVENTION

An object of the present invention is to provide: a non-magnetic toner for developing a latent electrostatic image, which has superior chargeability and stability in terms of durability, and which can form an image without background smear while maintaining fixability; a production method thereof, a developer using the toner; a toner container; a process cartridge; and an image forming apparatus.

Means for solving the above problems are as follows.

A toner of the present invention includes:

toner particles, each toner particle containing a toner base particle,

wherein the toner contains:

a binder resin; and

a colorant,

wherein the toner base particle has protrusions at a surface thereof,

wherein an average of lengths of long sides of the protrusions is 0.1 μm or more but less than 0.5 μm, a standard deviation of the lengths of the long sides of the protrusions is 0.20 or less, and a coverage rate of the protrusions is 30% to 90%,

wherein a resin forming the protrusions is prepared through polymerization of a monomer mixture containing at least a monomer having a sulfonic acid group, and

wherein the monomer mixture contains styrene in an amount of 90% by mass or more and the monomer having a sulfonic acid group in an amount of 0.1% by mass to 5% by mass.

In present invention, each toner base particle has protrusions at a surface thereof, and the protrusions are formed of those prepared through polymerization of a polymerizable monomer composition that contains a polymerizable monomer having a sulfonic acid group. This allows more sulfonic acid groups to be location at surfaces of toner base particles and, in addition, results in the increase of surface areas of the toner base particles due to the protrusions. As a result of such structure of the protrusions, compared to the tone completely coated with a shell, fixing is not inhibited, and the toner has improved chargeability, has stable developing properties over a long period, and can form satisfactory images without fog.

### BRIEF DESCRIPTION OF THE DRAWINGS

FIG. 1 is a diagram used for explaining a method for measuring protrusions of a toner in the present invention.

FIG. 2 is a schematic view showing a structure of a process cartridge according to an embodiment of the present invention.

FIG. 3 is a schematic cross-sectional view exemplarily showing a structure of an image forming apparatus according to an embodiment of the present invention.

FIG. 4 is a schematic cross-sectional view showing a structure of an image forming unit in which a photoconductor is placed.

FIG. 5 is a schematic cross-sectional view showing a structure of a developing device.

FIG. 6 is a schematic cross-sectional view showing a structure of a process cartridge.

FIG. 7 is an SEM image showing an appearance of a toner obtained in Example 1.

### DETAILED DESCRIPTION OF THE INVENTION

### (Toner)

The toner of the present invention includes at least a binder resin and a colorant, wherein the binder resin contains a non-crosslinked resin and/or a crosslinked resin, and the toner may further contain a layered inorganic mineral, a releasing agent, and other components.

The toner of the present invention contains toner particles, and each toner particle contains a toner base particle (which may be also referred to as “colored resin particle” in the specification) and an external additive, etc. optionally added to a surface of the toner base particle. In the present specification, the term “toner base particle” means a particle that has a core-shell structure and contains a core particle (which may be also referred to as “colored particle” in the specification) and a shell provided over the core particle where the shell constitutes protrusions at the surface of the toner base particle.

In the present invention, a toner composition refers to the ingredients included in the final product of the toner.

Further, in the present invention, a toner composition precursor refers to a precursor of the toner composition, which undergoes e.g. polymerization and serves as one ingredient of the toner composition, and the toner composition precursor specifically refers to, for example, a prepolymer and a monomer.

Conventionally, the surface of a core material has been covered with a shell material in order to achieve a core-shell structure. When the shell material is not bound to the core material sufficiently, the stress, for example, in a developing device, causes cracking and fracture, resulting in the contamination of a process member. In contrast, complete coverage of the core material with the shell material inhibits the releasing agent from oozing out upon fixing, causing deterioration of separability, or sufficient fixing strength is not obtained because heat does not travel to the core material.

The present invention can provide a toner which includes firmly bound protrusions, wherein the protrusions contains a sulfonic acid group. Because of the firmly bound protrusions, fixing of the toner is not inhibited and cracking and fracture are not generated in the developing device. Also, due to the inclusion of the sulfonic acid group in the protrusions, charging is not impaired over a long period and the toner has excellent anti-stress property.

The toner base particles having protrusions have a core-shell structure, preferably formed by adding an aqueous dispersion liquid, in which resin particles forming the shell material are dispersed, to an aqueous dispersion liquid of core particles to thereby allow the resin particles to adhere to the core particles.

As the toner of the present invention, a toner, prepared by adding external additives to toner base particles containing colored particles (i.e., core particles), where the colored particles include as essential ingredients a binder resin and a colorant, is used. The external additives are added in order to improve flowability, developability and chargeability. If necessary, the colored particles may include a releasing agent, a charge controlling agent and/or a plasticizer therein.

The toner includes protrusions composed of a resin forming a dispersoid. The protrusions are formed on the surfaces of the colored particles (i.e., core particles), to thereby improve cleanability and heat resistance storage stability while maintaining satisfactory low-temperature fixing property of the toner. Also, uniform size of the protrusions allows the toner to have uniform and stable chargeability and adhesion resistance, enabling high-quality image formation.

### <Binder Resin>

Examples of the binder resin include polyesters, polyurethanes, polyureas, epoxy resins and vinyl resins. Hybrid resins formed of chemically-combined different resins may be used. Reactive functional groups may be introduced to terminals or side chains of resins, and combined with each other in the process of preparing a toner to elongate. One type of the binder resin may be used, but preferably a resin of which the toner particles are formed is different from a resin of which the protrusions are formed in order to produce a toner having protrusions which have uniform size.

### <Resin Forming Colored Particles>

Resins, at least part of which dissolves in an organic solvent, are used as the resin forming colored particles and the acid value of the resin forming colored particles is preferably 2 mgKOH/g to 24 mgKOH/g. When the acid value is greater than 24 mgKOH/g, transfer of the resin forming colored particles to the aqueous phase easily occurs, and thus there may be a problem easily arising, such as decrease in the dispersion stability of the oil droplets or loss of substances in a production process. Also, the toner comes to absorb a larger amount of water, leading to degradation of chargeability and storage ability under high-temperature, high-humidity environment. When the acid value is less than 2 mgKOH/g, the polarity of the binder resin is low, and so it is difficult to uniformly disperse, in oil droplets, the colorant that has polarity to some extent.

The type of the resin is not particularly limited, however, in the case where the resin is used for a toner for developing an electrostatic image in electrophotography, it is preferred that the resin be a resin having a polyester backbone because satisfactory fixability can be obtained by using such resin having a polyester backbone. The resin having a polyester backbone includes polyester resins, and block polymers composed of polyesters and resins having backbones other than a polyester backbone. Polyester resins are preferably used since the obtained colored resin particles have high uniformity.

Examples of the polyester resin include ring-opening polymers of lactones, polycondensates of hydroxycarboxylic acid, and polycondensates of polyols and polycarboxylic acids. Of these, polycondensates of polyols and polycarboxylic acids are preferred since a wide variety of polyesters can be formed.

The peak molecular weight of the polyester resin is preferably 1,000 to 30,000, more preferably 1,500 to 10,000, still more preferably 2,000 to 8,000. When the peak molecular weight is lower than 1,000, the heat resistance storage stability of the toner is sometimes degraded. Whereas when the peak molecular weight exceeds 30,000, the low-temperature fixing property of the toner as a toner for developing an electrostatic image is degraded.

The glass transition temperature of the polyester resin forming core particles of the toner is 45° C. to 70° C., preferably 50° C. to 65° C. This allows the toner of the present invention to have a glass transition temperature, Tg1, of 45° C. to 70° C. Preferably, the toner has a glass transition temperature of 50° C. to 65° C. In the case where the core particle is covered with protrusions as in the present invention, atmospheric moisture may plasticize the resin in the protrusions during storage under high-temperature and high-humidity environment to thereby decrease the glass transition temperature. Presumably, the toner or toner cartridge is transported under high-temperature, high-humidity environment of 40° C. and 90% RH. Thus, when the glass transition temperature is lower than 45° C., the obtained colored resin particles are deformed under application of a certain pressure or stick to each other. As a result, there is a possibility that the toner particles cannot behave as particles. When the glass transition temperature is higher than 70° C., the formed toner is degraded in low-temperature fixing property when the colored resin particles are used as a latent electrostatic image developing toner. Needless to say, both cases are not preferred. The glass transition temperature of the toner, Tg1, is preferably lower than that of the resin forming protrusions, Tg2, which will be described later.

### <<Polyol>>

Examples of polyols (1) include diols (1-1) and trihydric or higher polyols (1-2), with (1-1) alone or a mixture containing (1-1) and a small amount of (1-2) being preferred. Examples of diols (1-1) include alkylene glycols (e.g., ethylene glycol, 1,2-propylene glycol, 1,3-propylene glycol, 1,4-butanediol and 1,6-hexanediol); alkylene ether glycols (e.g., diethylene glycol, triethylene glycol, dipropylene glycol, polyethylene glycol, polypropylene glycol and polytetramethylene ether glycol); alicyclic diols (e.g., 1,4-cyclohexanedimethanol and hydrogenated bisphenol A); bisphenols (e.g., bisphenol A, bisphenol F and bisphenol S); adducts of the above-listed alicyclic diols with alkylene oxides (e.g., ethylene oxide, propylene oxide and butylene oxide); 4,4′-dihydroxybiphenyls such as 3,3′-difluoro-4,4′-dihydroxybiphenyl; bis(hydroxyphenyl)alkanes such as bis(3-fluoro-4-hydroxyphenyl)methane, 1-phenyl-1,1-bis (3-fluoro-4-hydroxyphenyl)ethane, 2,2-bis (3-fluoro-4-hydroxyphenyl)propane, 2,2-bis (3,5-difluoro-4-hydroxyphenyl)propane (also known as tetrafluorobisphenol A) and 2,2-bis(3-hydroxyphenyl)-1,1,1,3,3,3-hexafluoropropane; bis(4-hydroxyphenyl)ethers such as his (3-fluoro-4-hydroxyphenyl)ether; and adducts of the above-listed bisphenols with alkylene oxides (e.g., ethylene oxide, propylene oxide and butylene oxide).

Of these, preferred are C2 to C12 alkylene glycols and alkylene oxide adducts of bisphenols. Particularly preferred are alkylene oxide adducts of bisphenols, and combinations of alkylene oxide adducts of bisphenols and C2 to C12 alkylene glycols.

Examples of the trihydric or higher polyols (1-2) include trihydric to octahydric or higher aliphatic polyalcohols (e.g., glycerin, trimethylolethane, trimethylolpropane, pentaerythritol and sorbitol); trihydric or higher phenols (e.g., trisphenol PA, phenol novolac and cresol novolac); and alkylene oxide adducts of the above trihydric or higher polyphenols.

### <<Polycarboxylic Acid>>

Examples of polycarboxylic acids (2) include dicarboxylic acids (2-1) and trivalent or higher polycarboxylic acids (2-2), with (2-1) alone or a mixture containing (2-1) and a small amount of (2-2) being preferred.

Examples of dicarboxylic acids (2-1) include alkylene dicarboxylic acids (e.g., succinic acid, adipic acid and sebacic acid); alkenylene dicarboxylic acids (e.g., maleic acid and fumaric acid); aromatic dicarboxylic acids (e.g., phthalic acid, isophthalic acid, terephthalic acid and naphthalene dicarboxylic acid), 3-fluoroisophthalic acid, 2-fluoroisophthalic acid, 2-fluoroterephthalic acid, 2,4,5,6-tetrafluoroisophthalic acid, 2,3,5,6-tetrafluoroterephthalic acid, 5-trifluoromethylisophthalic acid, 2,2-bis(4-carboxyphenyl)hexafluoropropane, 2,2-bis(3-carboxyphenyl)hexafluoropropane, 2,2′-bis(trifluoromethy0-4,4′-biphenyldicarboxylic acid, 3,3′-bis(trifluoromethyl)-4,4′-biphenyldicarboxylic acid, 2,2′-bis(trifluoromethyl)-3,3′-biphenyldicarboxylic acid and hexafluoroisopropylidenediphthalic anhydride. Of these, preferred are C4 to C20 alkenylenedicarboxylic acids and C8 to C20 aromatic dicarboxylic acids.

Examples of trivalent or higher polycarboxylic acids (2-2) include C9 to C20 aromatic polycarboxylic acids (e.g., trimellitic acid and pyromellitic acid). Notably, polycarboxylic acids (2) reacted with polyols (1) may be acid anhydrides or lower alkyl esters (e.g., methyl ester, ethyl ester and isopropyl ester) of the above carboxylic acids. The ratio between polyol and polycarboxylic acid is generally 2/1 to 1/2, preferably 1.5/1 to 1/1.5, more preferably 1.3/1 to 1/1.3, in terms of the equivalent ratio [OH]/[COOH] of the hydroxyl group [OH] to the carboxyl group [COON].

### <Modified Resin>

In order for the colored resin particles to have an increased mechanical strength and, when the colored resin particles are used as a latent electrostatic image developing toner, further involve no hot offset upon fixing, a modified resin containing an end isocyanate group may be dissolved in the oil phase for producing the colored resin particles. The method for producing the modified resin includes a method in which an isocyanate group-containing monomer is used for polymerization reaction to obtain an isocyanate group-containing resin; and a method in which a resin having an active hydrogen-containing group at its end is obtained through polymerization and then reacted with polyisocyanate to obtain a polymer containing an isocyanate group at its end. The latter method is preferred from the viewpoint of satisfactorily introducing an isocyanate group into the end of the polymer. Examples of the active hydrogen-containing group include a hydroxyl group (i.e., an alcoholic hydroxyl group and a phenolic hydroxyl group), an amino group, a carboxyl group and a mercapto group, with an alcoholic hydroxyl group being preferred. Considering uniformity of particles, the skeleton of the modified resin is preferably the same as that of a resin dissolvable in the organic solvent. The resin preferably has a polyester skeleton. In one employable method for producing a polyester having an alcoholic hydroxyl group at its end, polycondensation reaction is performed between a polyol having more functional groups (i.e., hydroxyl groups) and a polycarboxylic acid having less functional groups (i.e., carboxyl groups).

### —Amine Compound—

In the process of dispersing the oil phase in the aqueous phase to form particles, some isocyanate groups of the modified resin are hydrolyzed into amino groups, which are then reacted with unreacted isocyanate groups to allow elongation reaction to proceed. Also, an amine compound may be used in combination to perform elongation reaction and introduce crosslinked points as well as the above reaction. The amine compound (B) includes diamines (B1), trivalent or higher polyamines (B2), aminoalcohols (B3), aminomercaptans (B4), amino acids (B5) and amino-blocked compounds (B6) obtained by blocking the amino group of B1 to B5.

The diamine (B1) includes aromatic diamines (e.g., phenylene diamine, diethyltoluene diamine, 4,4′-diaminodiphenylmethane, tetrafluoro-p-xylylenediamine and tetrafluoro-p-phenylenediamine); alicyclic diamines (e.g., 4,4′-diamino-3,3′-dimethyldicyclohexylmethane, diaminecyclohexane and isophorondiamine); and aliphatic diamines (e.g., ethylenediamine, tetramethylenediamine, hexamethylenediamine, dodecafluorohexylenediamine and tetracosafluorododecylenediamine).

The trivalent or higher polyamine (B2) includes diethylenetriamine and triethylenetetramine.

The aminoalcohol (B3) includes ethanolamine and hydroxyethylaniline. The aminomercaptan (B4) includes aminoethylmercaptan and aminopropylmercaptan. The amino acid (B5) includes aminopropionic acid and aminocaproic acid.

The amino-blocked compound (B6) obtained by blocking the amino group of B1 to B5 includes oxazolidine compounds and ketimine compounds derived from the amines B1 to B5 and ketones (e.g., acetone, methyl ethyl ketone and methyl isobutyl ketone). Among these amines (B), preferred are B1 and a mixture containing B1 and a small amount of B2.

Regarding the amount of the amine (B) relative to the amount of the isocyanate group-containing prepolymer (A), the number of amino groups [NHx] in the amine (B) is four or less times, preferably twice or less, more preferably 1.5 or less times, further preferably 1.2 or less times, the number of isocyanate groups [NCO] in the isocyanate group-containing prepolymer (A). When the number of amino groups [NHx] in the amine (B) is more than four times the number of isocyanate groups [NCO] in the isocyanate group-containing prepolymer (A), excessive amino groups disadvantageously block isocyanate groups to prevent the elongation reaction of the modified resin. As a result, the polyester is decreased in molecular weight, resulting in degradation of hot offset resistance of the toner.

### —Organic Solvent—

The organic solvent is preferably a volatile organic solvent having a boiling point lower than 100° C. from the viewpoint of easy removal of the solvent. Examples of such organic solvent include toluene, xylene, benzene, carbon tetrachloride, methylene chloride, 1,2-dichloroethane, 1,1,2-trichloroethane, trichloroethylene, chloroform, monochlorobenzene, dichloroethylidene, methyl acetate, ethyl acetate, methyl ethyl ketone and methyl isobutyl ketone. These may be used alone or in combination. When the resin to be dissolved or dispersed in the organic solvent has a polyester skeleton, preferably used are ester solvents (e.g., methyl acetate, ethyl acetate and butyl acetate) or ketone solvents (e.g., methyl ethyl ketone and methyl isobutyl ketone) since these solvents have high dissolution capability to the resin. Among these, methyl acetate, ethyl acetate and methyl ethyl ketone are particularly preferred since these can be removed more easily.

### <Aqueous Medium>

The aqueous medium may be water alone or a mixture of water and a water-miscible solvent. The water-miscible solvent includes alcohols (e.g., methanol, isopropanol and ethylene glycol), dimethylformamide, tetrahydrofuran, cellosolves (e.g., methyl cellosolve) and lower ketones (e.g., acetone and methyl ethyl ketone).

### <Surfactant>

A surfactant is used for dispersing the oil phase in the aqueous medium to form liquid droplets.

Examples of the surfactant includes anionic surfactants such as alkylbenzenesulfonic acid salts, α-olefin sulfonic acid salts and phosphoric acid esters; cationic surfactants such as amine salts (e.g., alkyl amine salts, aminoalcohol fatty acid derivatives, polyamine fatty acid derivatives and imidazoline), and quaternary ammonium salts (e.g., alkyltrimethylammonium salts, dialkyl dimethylammonium salts, alkyl dimethyl benzyl ammonium salts, pyridinium salts, alkyl isoquinolinium salts and benzethonium chloride); nonionic surfactants such as fatty acid amide derivatives and polyhydric alcohol derivatives; and amphoteric surfactants such as alanine, dodecyldi(aminoethyl)glycine, di(octylaminoethyl)glycine and N-alkyl-N,N-dimethylammonium betaine. Also, a fluoroalkyl group-containing surfactant can exhibit its dispersing effects even in a very small amount.

A fluoroalkyl group-containing anionic surfactant suitably used includes fluoroalkyl carboxylic acids having 2 to 10 carbon atoms and metal salts thereof, disodium perfluorooctanesulfonylglutamate, sodium 3-[Ω-fluoroalkyl(C6 to C11)oxy]-1-alkyl(C3 or C4) sulfonates, sodium 3-[Ω-fluoroalkanoyl(C6 to C8)-N-ethylamino]-1-propanesulfonates, fluoroalkyl(C11 to C20) carboxylic acids and metal salts thereof, perfluoroalkylcarboxylic acids (C7 to C13) and metal salts thereof, perfluoroalkyl(C4 to C12)sulfonates and metal salts thereof, perfluorooctanesulfonic acid diethanol amide, N-propyl-N-(2-hydroxyethyl)perfluorooctanesulfone amide, perfluoroalkyl(C6 to C10)sulfonamide propyltrimethylammonium salts, salts of perfluoroalkyl(C6 to C10)-N-ethylsulfonylglycin and monoperfluoroalkyl(C6 to C16) ethylphosphates. The cationic surfactant includes aliphatic primary, secondary or tertiary amine acid containing a fluoroalkyl group, aliphatic quaternary ammonium salts (e.g., perfluoroalkyl (C6 to C10) sulfonamide propyltrimethylammonium salts), benzalkonium salts, benzethonium chloride, pyridinium salts and imidazolinium salts.

### <Inorganic Dispersing Agent>

The dissolution or dispersion product of the toner composition may be dispersed in the aqueous medium in the presence of an inorganic dispersing agent or resin particles. The inorganic dispersing agent includes tricalcium phosphate, calcium carbonate, titanium oxide, colloidal silica and hydroxyapatite. Use of the dispersing agent is preferred since a sharp particle size distribution and a stable dispersion state can be attained.

### <Protective Colloid>

Further, a polymeric protective colloid may be used to stabilize dispersed liquid droplets.

For example, acids (e.g., acrylic acid, methacrylic acid, α-cyanoacrylic acid, α-cyanomethacrylic acid, itaconic acid, crotonic acid, fumaric acid, maleic acid and maleic anhydride); hydroxyl group-containing (meth)acrylic monomers (e.g., β-hydroxyethyl acrylate, β-hydroxyethyl methacrylate, β-hydroxypropyl acrylate, β-hydroxypropyl methacrylate, γ-hydroxypropyl acrylate, γ-hydroxypropyl methacrylate, 3-chloro-2-hydroxypropyl acrylate, 3-chloro-2-hydroxypropyl methacrylate, diethylene glycol monoacrylic acid esters, diethylene glycol monomethacrylic acid esters, glycerin monoacrylic acid esters, glycerin monomethacrylic acid esters, N-methylolacrylamide and N-methylolmethacrylamide); vinyl alcohol and ethers thereof (e.g., vinyl methyl ether, vinyl ethyl ether and vinyl propyl ether), esters formed between vinyl alcohol and a carboxyl group-containing compound (e.g., vinyl acetate, vinyl propionate and vinyl butyrate); acrylamide, methacrylamide, diacetone acrylamide and methylol compounds thereof; acid chlorides (e.g., acrylic acid chloride and methacrylic acid chloride); homopolymers or copolymers of nitrogen-containing compounds and nitrogen-containing heterocyclic compounds (e.g., vinyl pyridine, vinyl pyrrolidone, vinyl imidazole and ethyleneimine); polyoxyethylenes (e.g., polyoxyethylene, polyoxypropylene, polyoxyethylene alkyl amines, polyoxypropylene alkyl amines, polyoxyethylene alkyl amides, polyoxypropylene alkyl amides, polyoxyethylene nonylphenyl ethers, polyoxyethylene laurylphenyl ethers, polyoxyethylene stearylphenyl esters and polyoxyethylene nonylphenyl esters); and celluloses (e.g., methyl cellulose, hydroxyethyl cellulose and hydroxypropyl cellulose) can be used.

When an acid- or alkali-soluble compound (e.g., calcium phosphate) is used as a dispersion stabilizer, the calcium phosphate used is dissolved with an acid (e.g., hydrochloric acid), followed by washing with water, to thereby remove it from the formed particles. Also, the calcium phosphate may be removed through enzymatic decomposition. Alternatively, the dispersing agent used may remain on the surfaces of the toner particles. But, the dispersing agent is preferably removed through washing after elongation and/or crosslinking reaction in terms of chargeability of the formed toner.

### <Colorant>

The colorant in the toner of the present invention is not particularly limited and known dyes and pigments can be used. Examples thereof include carbon black, nigrosine dye, iron black, naphthol yellow S, Hansa yellow (10G, 5G and G), cadmium yellow, yellow iron oxide, yellow ocher, yellow lead, titanium yellow, polyazo yellow, oil yellow, Hansa yellow (GR, A, RN and R), pigment yellow L, benzidine yellow (G and GR), permanent yellow (NCG), vulcan fast yellow (5G, R), tartrazinelake, quinoline yellow lake, anthrasan yellow BGL, isoindolinon yellow, colcothar, red lead, lead vermilion, cadmium red, cadmium mercury red, antimony vermilion, permanent red 4R, parared, fiser red, parachloroorthonitro aniline red, lithol fast scarlet G, brilliant fast scarlet, brilliant carmine BS, permanent red (F2R, F4R, FRL, FRLL and F4RH), fast scarlet VD, vulcan fast rubin B, brilliant scarlet G, lithol rubin GX, permanent red F5R, brilliant carmin 6B, pigment scarlet 3B, bordeaux 5B, toluidine Maroon, permanent bordeaux F2K, Helio bordeaux BL, bordeaux 10B, BON maroon light, BON maroon medium, eosin lake, rhodamine lake B, rhodamine lake Y, alizarin lake, thioindigo red B, thioindigo maroon, oil red, quinacridone red, pyrazolone red, polyazo red, chrome vermilion, benzidine orange, perinone orange, oil orange, cobalt blue, cerulean blue, alkali blue lake, peacock blue lake, victoria blue lake, metal-free phthalocyanin blue, phthalocyanin blue, fast sky blue, indanthrene blue (RS and BC), indigo, ultramarine, iron blue, anthraquinon blue, fast violet B, methylviolet lake, cobalt purple, manganese violet, dioxane violet, anthraquinon violet, chrome green, zinc green, chromium oxide, viridian, emerald green, pigment green B, naphthol green B, green gold, acid green lake, malachite green lake, phthalocyanine green, anthraquinon green, titanium oxide, zinc flower, lithopone and mixtures thereof.

<<Colorant Formed into Masterbatch>>

In the present invention, the colorant may be mixed with a resin to form a masterbatch.

Examples of the binder resin which is used for producing a masterbatch or which is kneaded together with a masterbatch include the above-described modified or unmodified polyester resins; styrene polymers and substituted products thereof (e.g., polystyrenes, poly-p-chlorostyrenes and polyvinyltoluenes); styrene copolymers (e.g., styrene-p-chlorostyrene copolymers, styrene-propylene copolymers, styrene-vinyltoluene copolymers, styrene-vinylnaphthalene copolymers, styrene-methyl acrylate copolymers, styrene-ethyl acrylate copolymers, styrene-butyl acrylate copolymers, styrene-octyl acrylate copolymers, styrene-methyl methacrylate copolymers, styrene-ethyl methacrylate copolymers, styrene-butyl methacrylate copolymers, styrene-methyl a-chloro methacrylate copolymers, styrene-acrylonitrile copolymers, styrene-vinyl methyl ketone copolymers, styrene-butadiene copolymers, styrene-isoprene copolymers, styrene-acrylonitrile-indene copolymers, styrene-maleic acid copolymers and styrene-maleic acid ester copolymers); polymethyl methacrylates; polybutyl methacrylates; polyvinyl chlorides; polyvinyl acetates; polyethylenes; polypropylenes, polyesters; epoxy resins; epoxy polyol resins; polyurethanes; polyamides; polyvinyl butyrals; polyacrylic acid resins; rosin; modified rosin; terpene resins; aliphatic or alicyclic hydrocarbon resins; aromatic petroleum resins; chlorinated paraffins; and paraffin waxes. These may be used alone or in combination.

### <<Preparation Method of Masterbatch>>

The masterbatch can be prepared by mixing/kneading a colorant with a resin for use in a masterbatch through application of high shearing force. Also, an organic solvent may be used for improving mixing between these materials. Further, the flashing method, in which an aqueous paste containing a colorant is mixed/kneaded with a resin and an organic solvent and then the colorant is transferred to the resin to remove water and the organic solvent, is preferably used, since a wet cake of the colorant can be directly used (i.e., no drying is required to be performed). In this mixing/kneading, a high-shearing disperser (e.g., three-roll mill) is preferably used.

### <External Additives>

The external additives are not particularly limited and inorganic particles and polymer particles known in the art can be preferably used. The primary particle diameter of the external additives is preferably 5 nm to 2 μm, more preferably 5 nm to 500 nm. The specific surface area determined by the BET method is preferably 20 m²/g to 500 m²/g. The amount of the external additives to be used is preferably 0.01% by mass to 5% by mass of the toner, particularly preferably 0.01% by mass to 2.0% by mass of the toner.

Specific examples of the inorganic particles include silica, alumina, titanium oxide, barium titanate, magnesium titanate, calcium titanate, strontium titanate, zinc oxide, tin oxide, silica sand, clay, mica, wollastonite, diatomaceous earth, chromium oxide, cerium oxide, red iron oxide, antimony trioxide, magnesium oxide, zirconium oxide, barium sulfate, barium carbonate, calcium carbonate, silicon carbide and silicon nitride.

Examples of the polymer particles include polystyrenes, methacrylic acid esters, acrylate copolymers, polycondensates (e.g., silicone, benzoguanamine and nylon (registered trademark)) and polymer particles of thermosetting resins, which are produced through soap-free emulsion polymerization, suspension polymerization and dispersion polymerization.

A fluidizing agent is an agent improving hydrophobic properties through surface treatment, and is capable of inhibiting the degradation of flowability or chargeability under high humidity environment. Preferred examples of a surface treating agent include silane coupling agents, silylation agents, silane coupling agents having a fluorinated alkyl group, organotitanate coupling agents, aluminum coupling agents, silicone oils, and modified silicone oils.

### <Releasing Agent>

In order for the toner to have an increased releasing property during fixing when the colored resin particles are used as a latent electrostatic image developing toner, a releasing agent may be dispersed in the organic solvent in advance.

The releasing agent may be, for example, wax and silicone oil that exhibit a sufficiently low viscosity when heated during the fixing process and that are difficult to be compatible or swelled with other colored resin particles materials on the fixing member surface. Considering the storage stability of the colored resin particles themselves, preferably used is wax that generally exists as a solid in the colored resin particles during storage.

The wax includes long-chain hydrocarbons and carbonyl group-containing waxes. Examples of the long-chain hydrocarbon include polyolefin waxes (e.g., polyethylene wax and polypropylene wax); petroleum waxes (e.g., paraffin waxes, SASOL wax and microcrystalline waxes); and Fischer-Tropsch waxes. Examples of the carbonyl group-containing wax include polyalkanoic acid esters (e.g., carnauba wax, montan wax, trimethylolpropane tribehenate, pentaerythritol tetrabehenate, pentaerythritol diacetatedibehenate, glycerine tribehenate and 1,18-octadecanediol distearate); polyalkanol esters (e.g., tristearyl trimellitate and distearyl malleate); polyalkanoic acid amides (e.g., ethylenediamine dibehenylamide); polyalkylamides (e.g., trimellitic acid tristearylamide); and dialkyl ketones (e.g., distearyl ketone).

Of these, long-chain hydrocarbons are preferred since they exhibit better releasing property. Furthermore, the long-chain hydrocarbons may be used in combination with the carbonyl group-containing waxes. The amount of the releasing agent contained in the colored resin particles is 2% by mass to 25% by mass, preferably 3% by mass to 20% by mass, more preferably 4% by mass to 15% by mass. When it is less than 2% by mass, the releasing property of the formed toner cannot be obtained during fixing. Whereas when it is more than 25% by mass, the formed colored resin particles are degraded in mechanical strength.

### <Charge Controlling Agent>

If necessary, a charge controlling agent may be dissolved or dispersed in the organic solvent in advance.

The charge controlling agent may be any known charge controlling agent. Examples thereof include nigrosine dyes, triphenylmethane dyes, chrome-containing metal complex dyes, molybdic acid chelate pigments, rhodamine dyes, alkoxy amines, quaternary ammonium salts (including fluorine-modified quaternary ammonium salts), alkylamides, phosphorus, phosphorus compounds, tungsten, tungsten compounds, fluorine active agents, metal salts of salicylic acid, and metal salts of salicylic acid derivatives. Specific examples include nigrosine dye BONTRON 03, quaternary ammonium salt BONTRON P-51, metal-containing azo dye BONTRON S-34, oxynaphthoic acid-based metal complex E-82, salicylic acid-based metal complex E-84 and phenol condensate E-89 (these products are of ORIENT CHEMICAL INDUSTRIES CO., LTD), quaternary ammonium salt molybdenum complex TP-302 and TP-415 (these products are of Hodogaya Chemical Co., Ltd.), quaternary ammonium salt COPY CHARGE PSY VP 2038, triphenylmethane derivative COPY BLUE PR, quaternary ammonium salt COPY CHARGE NEG VP2036 and COPY CHARGE NX VP434 (these products are of Hoechst AG), LRA-901 and boron complex LR-147 (these products are of Japan Carlit Co., Ltd.), copper phthalocyanine, perylene, quinacridone, azo pigments, and polymeric compounds having, a functional group such as a sulfonic acid group, carboxyl group, or quaternary ammonium salt.

Any amount of the charge controlling agent contained in the toner may be used so long as the charge controlling agent can exhibit its performances without degrading the fixing property of the toner. The amount thereof is 0.5% by mass to 5% by mass, preferably 0.8% by mass to 3% by mass.

### <Production Method of Toner>

The production method of toner is not particularly limited and may be appropriately selected depending on the intended purpose. Examples thereof include known wet process granulation methods such as a dissolution suspension method, a suspension polymerization method, and an emulsification aggregation method, and pulverizing methods. Among these, a dissolution suspension method and an emulsification aggregation method (emulsification polymerization method) are preferable in terms of easiness for controlling the particle diameter and shape of the toner.

When colored particles serving as core particles are produced by an emulsification method or suspension polymerization method, first colored particles (core particles) are produced by a known method of each method, and resin particles (particles forming the protrusions) are then added to the reaction system, so that the resin particles are attached to and fused with the surfaces of the colored particles serving as core particles. Here, the reaction system may be heated to promote attachment and fusion of the resin particles. Also, use of a metal salt is effective in promoting the attachment and fusion.

### <Resin Particles: Protrusions>

In the toner of the present invention, the resin particles forming the protrusions can be the resin particles dispersed in the aqueous medium. The resin particles forming the protrusions are prepared through polymerization of a monomer mixture containing a monomer having a sulfonic acid group. The monomer mixture contains styrene in an amount of 90% by mass or more and the monomer having a sulfonic acid group in an amount of 0.1% by mass to 5% by mass.

The resin forming the protrusions of the toner of the present invention is prepared through polymerization of the monomer mixture. The amount of a monomer having a sulfonic acid group in the monomer mixture is 0.1% by mass to 5% by mass, preferably 0.5% by mass to 4% by mass, more preferably 1% by mass to 3% by mass. If the amount of the monomer with a sulfonic acid group is less than 0.1% by mass, improvement in chargeability cannot be achieved sufficiently, deteriorating image quality due to, for example, background smear. If the amount of the monomer with a sulfonic acid group is greater than 5% by mass, the resin containing a sulfonic acid group is increased in hydrophilic property. This prevents the incorporation of resin particles into the toner in some cases. Even if they are incorporated, the protrusions projects from the surface more than desired, causing detachment in some cases. This causes reduction in charge and also causes defects in images due to peeling, and deterioration of heat resistance storage stability.

Also, the amount of styrene in the protrusions is 90% by mass or more, preferably 95% by mass or more. When it is less than 90% by mass, the protrusions have low strength and the toner has poor anti-stress property and cannot have satisfactory charge performance over a long period.

The monomer having a sulfonic acid group is not particularly limited, as long as it is a polymerizable compound with a sulfonic acid group, but it is preferably a compound represented by the following General Formula 1

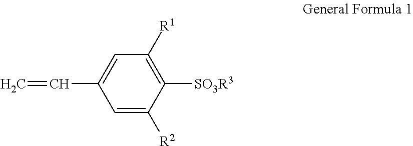

In General Formula 1, R¹ and R² each independently represent a substituent selected from a hydrogen atom, an alkyl group, and an alkenyl group; and R³ represents any one of a hydrogen atom, an alkali metal element, an alkyl group, and an alkenyl group.

In the General Formula 1, as described above, R¹ and R² each independently represent a substituent selected from a hydrogen atom, an alkyl group, and an alkenyl group, but R¹ and R² are preferably a hydrogen atom or an alkyl group, more preferably a hydrogen atom or a C1-C4 alkyl group, still more preferably a hydrogen atom or a methyl group, particularly preferably a hydrogen atom.

In the General Formula 1, as described above, R³ represents any one of a hydrogen atom, an alkali metal element, an alkyl group, and an alkenyl group, but R³ is preferably a C1-C4 alkyl group or a alkali metal, more preferably a methyl group, an ethyl group or a Na atom, particularly preferably a methyl group or an ethyl group.

Examples of the polymerizable compound having a sulfonic acid group include acrylamide-2-methylpropanesulfonic acid, p-styrene sulfonate ethyl ester, sodium p-styrenesulfonate, potassium p-styrenesulfonate, lithium p-styrenesulfonate, methyl ester of p-styrenesulfonic acid, propyl ester of p-styrenesulfonic acid, isopropyl ester of p-styrenesulfonic acid, n-butyl ester of p-styrenesulfonic acid, sec-butyl ester of p-styrenesulfonic acid, tert-butyl ester of p-styrenesulfonic acid, hexyl ester of p-styrenesulfonic acid, cyclohexyl ester of p-styrenesulfonic acid, 2-ethylhexyl ester of p-styrenesulfonic acid, and phenyl ester of p-styrenesulfonic acid. These may be used alone or in combination.

Styrene resins containing styrene as a main component are preferred as the resin forming the protrusions from the viewpoint of easily obtaining the resin particles dispersed in the aqueous medium as described above. Examples of the method for preparing aqueous dispersoids of vinyl resin particles include known polymerization methods such as an emulsification aggregation method, a suspension polymerization method and a dispersion polymerization method. Of these, an emulsification aggregation method is particularly preferred from the viewpoint of easily obtaining particles having a particle diameter suitable for the present invention.

In order for the colored resin particles obtained in the present invention to be used as charged functional particles like latent electrostatic image developing toner particles, the colored resin particles each preferably have an easily chargeable surface. Therefore, other monomer to be included in the resin particles forming the protrusions is preferably a styrene monomer which has electron orbitals where electrons can stably travel as can be seen in aromatic ring structures.

Here, the styrene monomer refers to an aromatic compound having a vinyl polymerizable functional group. The polymerizable functional group includes a vinyl group, an isopropenyl group, an allyl group, an acryloyl group and a methacryloyl group.

Specific examples of the styrene monomer include styrene, α-methylstyrene, 4-methylstyrene, 4-ethylstyrene, 4-tert-butylstyrene, 4-methoxystyrene, 4-ethoxystyrene, 4-carboxystyrene and metal salts thereof; 4-styrenesulfonic acid and metal salts thereof; 1-vinylnaphthalene, 2-vinylnaphthalene, allylbenzene, phenoxyalkylene glycol acrylate, phenoxyalkylene glycol methacrylate, phenoxypolyalkylene glycol acrylates and phenoxypolyalkylene glycol methacrylates. Of these, preferably, styrene is mainly used since it is easily available, and has excellent reactivity and high chargeability.

Also, a monomer having an ethylene oxide (EO) chain may be used for controlling compatibility to the colored particles. Examples thereof include phenoxyalkylene glycol acrylate, phenoxyalkylene glycol methacrylate, phenoxypolyalkylene glycol acrylates and phenoxypolyalkylene glycol methacrylates. The amount of the EO chain-containing monomer used is 10% by mass or less, preferably 5% by mass or less, more preferably 2% by mass or less, relative to the total amount of the monomers. When the amount thereof is greater than 10% by mass, an increased number of polar groups on the toner surface considerably degrade charge stability to the environment, which is not preferred. In addition, the compatibility to the colored particles becomes too high, resulting in that the embedment rates of the protrusions tend to be unfavorably decreased.

Also, a monomer having an ester bond (e.g., 2-acryloyloxyethyl succinate or 2-methacryloyloxyethyl phthalate) may simultaneously be used for controlling compatibility to the colored particles. In this case, the amount of such a monomer used is 10% by mass or less, preferably 5% by mass or less, more preferably 2% by mass or less, relative to the total amount of the monomers. When the amount thereof is greater than 10% by mass, an increased number of polar groups on the toner surface considerably degrade charge stability to the environment, which is not preferred. In addition, the compatibility to the colored particles becomes too high, resulting in that the embedment rates of the protrusions tend to be unfavorably decreased.

The method for obtaining the resin particles is not particularly limited, and exemplified by the following methods (a) to (f);

(a) a method in which a monomer mixture is allowed to undergone polymerization reaction with a suspension polymerization method, an emulsification polymerization method, a seed polymerization method or a dispersion polymerization method, to thereby produce a dispersion liquid of resin particles;
(b) a method in which a monomer mixture is allowed to undergone polymerization, and the obtained resin is then pulverized using a fine pulverizer of, for example, mechanically rotating type or jetting type, followed by classifying, to thereby produce resin particles;
(c) a method in which a monomer mixture is allowed to undergone polymerization, and the obtained resin is then dissolved in a solvent, followed by spraying of the resultant resin solution, to thereby produce resin particles;
(d) a method in which a monomer mixture is allowed to undergone polymerization, the obtained resin is dissolved in a solvent, another solvent is added to the resultant resin solution to precipitate resin particles, and then the solvent is removed to obtain resin particles; or a method in which a monomer mixture is allowed to undergone polymerization, the obtained resin is dissolved in a solvent with heating, the resultant resin solution is cooled to precipitate resin particles, and then the solvent is removed to obtain resin particles;
(e) a method in which a monomer mixture is allowed to undergone polymerization, the obtained resin is dissolved in a solvent, the resultant resin solution is dispersed in an aqueous medium in the presence of an appropriate dispersing agent, and then the dispersion liquid is, for example, heated or left under reduced pressure to remove the solvent; and
(f) a method in which a monomer mixture is allowed to undergone polymerization, the obtained resin is dissolved in a solvent, an appropriate emulsifying agent is dissolved in the resultant resin solution, followed by phase-transfer emulsification with the addition of water.

Of these, method (a) is preferably employed, since resin particles can be easily produced as a dispersion liquid, which is easy to use for the next step.

In the polymerization reaction of method (a), preferably, (i) a dispersion stabilizer is added to the aqueous medium, (ii) the monomer mixture to be allowed to undergone polymerization reaction is made to contain a monomer capable of imparting dispersion stability to the resin particles obtained through polymerization (i.e., a reactive emulsifier) or the above (i) and (ii) are performed in combination, to thereby impart dispersion stability to the obtained resin particles. When neither the dispersion stabilizer nor the reactive emulsifier is used, the particles cannot be maintained in a dispersion state whereby the styrene resin cannot be obtained as particles, the obtained resin particles are poor in dispersion stability whereby they are poor in storage stability resulting in aggregation during storage, or the particles are degraded in dispersion stability at the below-described resin particle-attaching step whereby the core particles easily aggregate or combined together resulting in that the finally obtained colored resin particles are degraded in evenness of, for example, particle diameter,

The dispersion stabilizer includes surfactants and inorganic dispersing agents. Examples of the surfactant include anionic surfactants such as alkylbenzenesulfonic acid salts, α-olefinsulfonic acid salts and phosphoric acid esters; cationic surfactants such as amines (e.g., alkylamine salts, aminoalcohol fatty acid derivatives, polyamine fatty acid derivatives and imidazoline) and quaternary ammonium salts (e.g., alkyltrimethyl ammonium salts, dialkyldimethyl ammonium salts, alkyldimethylbenzyl ammonium salts, pyridinium salts, alkylisoquinolinium salts and benzethonium chloride); nonionic surfactants such as fatty acid amide derivatives and polyalcohol derivatives; and amphoteric surfactants such as alanine, dodecydi(aminoethyl)glycine, di(octylaminoethyl)glycine and N-alkyl-N,N-dimethylammonium betaine. Examples of the inorganic dispersing agent include tricalcium phosphate, calcium carbonate, titanium oxide, colloidal silica and hydroxyapatite.

The weight average molecular weight of the styrene resin is 3,000 to 300,000, preferably 4,000 to 100,000, more preferably 5,000 to 50,000. When the weight average molecular weight is lower than 3,000, the styrene resin has low mechanical strength (i.e., is brittle). Thus, the surfaces of the finally obtained colored resin particles easily change depending on the working environment of some applications. For example, the colored resin particles considerably changes in chargeability and/or causes contamination such as attachment onto the surrounding members, which leads to degradation of image quality. Whereas when the weight average molecular weight is higher than 300,000, the number of ends of the molecules is decreased, so that the molecular chains interact with the core particles to a less extent to degrade adhesion to the core particles, which is not preferred.

The glass transition temperature, Tg2, of the resin forming the protrusions is 45° C. to 100° C., preferably 50° C. to 90° C., more preferably 50° C. to 80° C., still more preferably 60° C. to 80° C. When stored under high-temperature and high-humidity environment, atmospheric moisture may plasticize the resin in the protrusions to thereby decrease the glass transition temperature. Presumably, the toner or toner cartridge is transported under high-temperature, high-humidity environment of 40° C. and 90% RH. Thus, when the glass transition temperature is lower than 45° C., the obtained colored resin particles are deformed under application of a certain pressure or stick to each other. As a result, there is a possibility that the colored resin particles cannot behave as particles. In addition, when used for a one-component developer, the toner becomes poor in durability to friction. Whereas when the Tg2 exceeds 100° C., the low-temperature fixing property is degraded. Needless to say, both cases are not preferred.

The glass transition temperature of the resin forming the protrusions, Tg2, is preferably higher than that of the toner, Tg1. In order to achieve low-temperature fixing property, it is preferable that the core particle part have a low glass transition temperature. However, this deteriorates stress resistance and/or heat resistance storage stability of the toner. It is thus preferable to design the toner such that the core particle part has a low glass transition temperature and the protrusions have a high Tg2 in order to improve stress resistance and heat resistance storage stability of the toner while maintaining low-temperature fixing property.

### <<Preparation Step of Oil Phase>>

The oil phase, which contains an organic solvent, and materials such as a resin and a colorant dissolved or dispersed in the organic solvent, may be prepared in the following manner. Specifically, the materials such as the resin and the colorant are gradually added to the organic solvent under stirring so that these materials are dissolved or dispersed therein. Notably, when a pigment is used as the colorant and/or when materials such as the releasing agent and the charge controlling agent used are poorly dissolvable to the organic solvent, the particles of these materials are preferably micronized before the addition to the organic solvent.

As described above, the colorant may be formed into a masterbatch. Similarly, the materials such as the releasing agent and the charge controlling agent may be formed into a masterbatch.

In another means, the colorant, the releasing agent and the charge controlling agent may be dispersed through a wet process in the organic solvent, if necessary in the presence of a dispersion aid, to thereby obtain a wet master.

In still another means, when dispersing the materials melted at a temperature lower than the boiling point of the organic solvent, they are heated together with the dispersoids under stirring in the organic solvent, if necessary in the presence of a dispersion aid; and the resultant solution is cooled with stirring or shearing so that the dissolved materials are crystallized, to thereby produce microcrystals of the dispersoids.

After the colorant, releasing agent and charge controlling agent, dispersed with any of the above means, have been dissolved or dispersed in the organic solvent together with a resin, the resultant mixture may be further dispersed. The dispersion may be performed using a known disperser such as a bead mill or a disc mill.

### <Preparation Step of Colored Particles>

No particular limitation is imposed on the method for preparing a dispersion liquid containing colored particles formed of the oil phase by dispersing the oil phase obtained at the above-described step in the aqueous medium containing at least the surfactant. This method may use a known disperser such as a low-speed shearing disperser, a high-speed shearing disperser, a friction disperser, a high-pressure jet disperser or an ultrasonic disperser. Among them, a high-speed shearing disperser is preferably used to form dispersoids having a particle diameter of 2 μm to 20 μm.

The rotation speed of the high-speed shearing disperser is not particularly limited but is generally 1,000 rpm to 30,000 rpm, preferably 5,000 rpm to 20,000 rpm. The dispersion time is not particularly limited but is generally 0.1 min to 5 min in a batch method. When the dispersion time exceeds 5 min, unfavorable small particles remain and excessive dispersion is performed to make the dispersion system unstable, potentially forming aggregates and coarse particles, which is not preferred. The dispersion temperature is generally 0° C. to 40° C., preferably 10° C. to 30° C. When the dispersion temperature exceeds 40° C., molecular movements are excited to degrade dispersion stability, easily forming aggregates and coarse particles, which is not preferred. Whereas when the dispersion temperature is lower than 0° C., the dispersion liquid is increased in viscosity to require elevated shear energy for dispersion, leading to a drop in production efficiency.

The surfactant usable may be the same as those mentioned in the above-described production method of the resin particles. In order to efficiently disperse the oil droplets containing the solvent, the surfactant used is preferably a disulfonic acid salt having a relatively high HLB. The concentration of the surfactant in the aqueous medium is 1% by mass to 10% by mass, preferably 2% by mass to 8% by mass, more preferably 3% by mass to 7% by mass. When the concentration thereof exceeds 10% by mass, each oil droplet becomes too small and also has a reverse micellar structure. Thus, the dispersion stability is degraded due to the surfactant added in such an amount, to thereby easily form coarse oil droplets. Whereas when the concentration thereof is lower than 1% by mass, the oil droplets cannot be stably dispersed to form coarse oil droplets. Needless to say, both cases are not preferred.

### <Method for Forming Protrusions>

The protrusions in the present invention are parts that project from the surface of the toner base particle and the tip thereof tends to have an almost spherical shape due to surface tension. The way protrusions are fused with the surface is not particularly limited. For example, part of spherical protrusions is embedded or hemispherical protrusions are fused with the surface.

The method for forming protrusions include a method in which resin particles formed of at least a resin are attached to and fused with the colored particles, serving as a core, which contains at least a binder resin and a colorant. In order to allow the resin particles to be efficiently attached to and fused with the colored particles, serving as a core, theses particles are first dispersed in an aqueous medium and then attachment and fuse are carried out while controlling a dispersion stabilizer.

Here, the shape and evenness of the protrusions are determined by the content of the surfactant in the aqueous medium, the composition of the resin particles, and when fusing step is performed.

The dissolution suspension method may be performed as described above. However, the following method is preferably employed since the resin particles are attached onto or fused with the colored particles more firmly. Specifically, the method includes dissolving or dispersing materials of the colored particles, serving as a core, in an organic solvent to prepare an oil phase, dispersing the oil phase in an aqueous medium, and adding resin particles so as to be attached onto and fused with the surfaces of liquid droplets of the oil phase. Addition of the resin particles at the production step of toner core particles forms large, ununiform protrusions, which is not preferred.

Next, description will be given to the resin particle-attaching step, taking as an example the case where vinyl resin particles are used as the resin particles.

The obtained colored particle dispersion liquid contains stable liquid droplets of the core particles, so long as the dispersion liquid is being stirred. For attaching the resin particles onto the colored particles, the resin particle dispersion liquid is added to this core particle slurry. The period for which the styrene resin particle dispersion liquid is added is 30 sec or longer. When it is added over a period shorter than 30 sec, the dispersion system drastically changes to form aggregated particles. In addition, the styrene resin particles are ununiformly attached onto the colored particles, which is not preferred. Meanwhile, adding the styrene resin particle dispersion liquid over an unnecessarily long period of time (e.g., 60 min or longer) cannot be preferred from the viewpoint of lowering production efficiency.

Before added to the core particle dispersion liquid, the styrene resin particle dispersion liquid may be appropriately diluted or concentrated so as to have a desired concentration. The concentration of the styrene resin particle dispersion liquid is preferably 5% by mass to 30% by mass, more preferably 8% by mass to 20% by mass. When the concentration is less than 5% by mass, the concentration of the organic solvent greatly changes upon addition of the dispersion liquid to lead to insufficient attachment of the resin particles, which is not preferred. Also, when the concentration exceeds 30% by mass, the resin particles tend to be localized in the core particle dispersion liquid, resulting in that the resin particles are ununiformly attached onto the colored particles, which should be avoided.

Also, for the production of liquid droplets of the oil phase, the amount of the surfactant contained in the aqueous phase is 7% by mass or less, preferably 6% by mass or less, more preferably 5% by mass or less. When the amount of the surfactant exceeds 7% by mass, the protrusions have considerably decreased uniformity in the length of the long side, which is not preferred.

The following may explain the reason why the styrene resin particles are sufficiently firmly attached onto the core particles by the method of the present invention. Specifically, when the styrene resin particles are attached onto the liquid droplets of the core particles, the core particles can freely deform to sufficiently form contact surfaces with the styrene resin particles and the styrene resin particles are swelled with or dissolved in the organic solvent to make it easier for the styrene resin particles to adhere to the resin in the core particles. Therefore, in this state, the organic solvent must exist in the system in a sufficiently large amount. Specifically, in the core particle dispersion liquid, the amount of the organic solvent is 50% by mass to 150% by mass, preferably 70% by mass to 125% by mass, relative to the amount of the solid matter (e.g., resin, colorant, if necessary, releasing agent and charge controlling agent). When the amount of the organic solvent exceeds 150% by mass, the amount of the colored resin particles obtained through one production process is reduced, resulting in low production efficiency. Also, a large amount of the organic solvent impairs dispersion stability, making it difficult to attain stable production, which is not preferred.

The temperature at which the styrene resin particles are made to attach onto the core particles is 10° C. to 60° C., preferably 20° C. to 45° C. When it exceeds 60° C., required energy for production is elevated to increase environmental loading, and the presence of styrene resin particles having a low acid value on the surfaces of liquid droplets makes the dispersion system to be unstable to thereby potentially form coarse particles. Meanwhile, when the temperature is less than 10° C., the dispersion liquid is increased in viscosity, leading to an insufficiently attachment of the resin particles. Needless to say, both cases are not preferred.

The rate of the resin forming resin particles relative to the total mass of the toner is 1% by mass to 20% by mass, preferably 3% by mass to 15% by mass, more preferably 5% by mass to 10% by mass. When the rate thereof is less than 1% by mass, satisfactory effects cannot be obtained. Whereas when the rate thereof is more than 20% by mass, excessive resin particles are weakly attached onto the toner core particles, causing filming or other unfavorable phenomena.

The method for forming protrusions includes, in addition to the methods described above, a method in which the toner particle base and the resin particles may be mixed together under stirring so as to attain mechanical adhesion or coating of the resin particles on the toner particle base.

<<desolvation step>>

In one employable method for removing the organic solvent from the obtained colored resin dispersion liquid, the entire system is gradually increased in temperature with stirring, to thereby completely evaporate off the organic solvent contained in the liquid droplets.

In another employable method, the obtained colored resin dispersion liquid with stirring is sprayed toward a dry atmosphere, to thereby completely evaporate off the organic solvent contained in the liquid droplets. In still another employable method, the colored resin dispersion liquid is reduced in pressure with stirring to evaporate off the organic solvent. The latter two methods may be used in combination with the first method.

The dry atmosphere toward which the emulsified dispersion liquid is sprayed generally uses heated gas (e.g., air, nitrogen, carbon dioxide and combustion gas), especially, gas flow heated to a temperature equal to or higher than the highest boiling point of the solvents used. By removing the organic solvent even in a short time using, for example, a spray dryer, a belt dryer or a rotary kiln, the resultant product has satisfactory quality.

<Aging step>

When a modified resin having an end isocyanate group is added, an aging step may be performed to allow elongation/crosslinking reaction of the isocyanate to proceed. The aging time is generally 10 min to 40 hours, preferably 2 hours to 24 hours. The aging temperature is generally 0° C. to 65° C., preferably 35° C. to 50° C.

<Washing step>

The dispersion liquid of the colored resin particles obtained in the above-described manner contains not only the colored resin particles but also such subsidiary materials as the surfactant and dispersing agent. Thus, the dispersion liquid is washed to separate the colored resin particles from the subsidiary materials. Examples of the washing method of the colored resin particles include a centrifugation method, a reduced-pressure filtration method and a filter press method, but employable washing methods in the present invention are not limited thereto. Any of the above methods forms a cake of the colored resin particles. If the colored resin particles are not sufficiently washed through only one washing process, the formed cake may be dispersed again in an aqueous solvent to form a slurry, which is repeatedly treated with any of the above methods to take out the colored resin particles. When a reduced-pressure filtration method or a filter press method is employed for washing, an aqueous solvent may be made to penetrate the cake to wash out the subsidiary materials contained in the colored resin particles. The aqueous solvent used for washing is water or a solvent mixture of water and an alcohol such as methanol or ethanol. Use of water is preferred from the viewpoint of reducing cost and environmental load caused by, for example, drainage treatment.

### <Drying Step>

The washed colored resin particles containing the aqueous medium in a large amount are dried to remove the aqueous medium, whereby only colored resin particles can be obtained. The drying method uses, for example, a spray dryer, a vacuum freezing dryer, a reduced-pressure dryer, a ventilation shelf dryer, a movable shelf dryer, a fluidized-bed-type dryer, a rotary dryer or a stirring-type dryer. The colored resin particles are preferably dried until the water content is finally decreased less than 1% by mass. Also, when the dry colored resin particles flocculate to cause inconvenience in use, the flocculated particles may be separated from each other through beating using, for example, a jet mill, HENSCHEL MIXER, a super mixer, a coffee mill, an oster blender or a food processor.

### (Developer)

The developer of the present invention includes at least the toner of the present invention, and, further includes appropriately selected other components such as a carrier. The developer may be a one-component developer that is used for non-magnetic one-component developing methods or a two-component developer that contains a carrier.

### (Toner Container)

A toner container of the present invention contains therein the toner of the present invention. The container is not particularly limited, may be appropriately selected from known containers, and includes, for example, a container including a container body and a cap.

The size, shape, structure and material of the container body are not particularly limited. The shape is preferably a cylindrical shape, and particularly preferably a shape in which spiral irregularity is formed on the internal periphery and the developer as the content can be migrated to the side of a discharge port and also a portion or all of the spiral section has a bellow function. The material of the container body is not particularly limited, but is preferably excellent in dimensional accuracy. Examples thereof include resin materials such as polyester resins, polyethylene resins, polypropylene resins, polystyrene resins, polyvinyl chloride resins, polyacrylic resins, polycarbonate resins, ABS resins and polyacetal resins.

The toner container is easily stored and transported and is excellent in handling properties, and also can be used to refill the developer by detachably attaching to the process cartridge or the image forming apparatus described below.

### (Process Cartridge)

The toner of the present invention obtained by the production method can be suitably used for the process cartridge of the present invention.

A process cartridge of the present invention includes at least a latent electrostatic image bearing member and a developing unit configured to develop a latent electrostatic image formed on the latent electrostatic image bearing member with the toner to form a visible image.

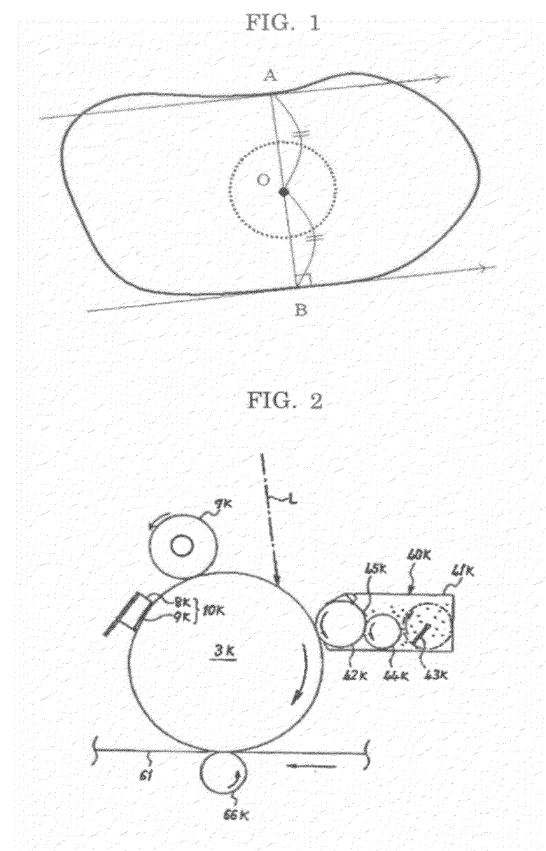

The toner of the present invention can be used in an image forming apparatus provided with a process cartridge shown, for example, in FIG. 2.

The process cartridge shown in FIG. 2 includes a latent electrostatic image bearing member 3K, a charging unit 7K, a charging member 10K configured to recharge toner remaining on the surface of the latent electrostatic image bearing member after the transfer of images from the latent electrostatic image bearing member to a member in a subsequent step, and a developing unit 40K. This process cartridge is mounted detachably to the main body of an image forming apparatus such as a copier or a printer.

In the operation of this process cartridge, the latent electrostatic image bearing member 3K is rotated at a predetermined peripheral speed. In the course of rotating, the latent electrostatic image bearing member 3K receives from the charging unit 7K a uniform, positive or negative electrical charge of a specific potential around its periphery, and then receives image exposure light L from an image exposing unit, such as slit exposure or laser beam scanning exposure, and latent electrostatic images are sequentially formed on the surface of the latent electrostatic image bearing member 3K. Then the formed latent electrostatic images are developed with a toner by the developing unit 40K, and the developed images (toner images) are sequentially transferred by a transfer unit 66K to a transfer target material 61 fed from a paper feed unit (not shown) to the part between the latent electrostatic image bearing member 3K and the transfer unit 66K in synchronization with the rotation of the latent electrostatic image bearing member 3K.

The transfer target material 61 to which the images have been transferred is then separated from the surface of the latent electrostatic image bearing member and introduced to an image fixing unit so as to fix the images to the transfer target material 61, and subsequently the transfer target material 61 with the fixed images is printed out as a copy or a print to the outside of the apparatus.

On the surface of the latent electrostatic image bearing member 3K after the image transfer, residual toner which was not transferred is recharged by the charging member 10K that includes an elastic portion 8K and a conductive sheet 9K (formed of a conductive material) and that is configured to recharge toner remaining on the surface of the latent electrostatic image bearing member after the transfer of images from the latent electrostatic image bearing member to a member in a subsequent step. Then the toner is passed through the latent electrostatic image bearing member charging section, recovered in a developing step and repeatedly used for image formation.

The developing unit 40K includes a casing 41K, and a developing roller 42K, the circumferential surface of which is partially exposed from an opening provided in the casing 41K.

Regarding the developing roller 42K serving as a developer bearing member, shafts protruding from both ends thereof with respect to the lengthwise direction are supported in a rotatable manner by respective bearings (not shown).

The casing 41K houses a K toner, and the K toner is conveyed by a rotationally driven agitator 43K from the right side to the left side in the drawing.

At the left side (in the drawing) of the agitator 43K, there is provided a toner supplying roller 44K which is rotationally driven in a counterclockwise direction (in the drawing) by a drive unit (not shown). The roller portion of this toner supplying roller 44K is made of an elastic foamed material such as a sponge and thus favorably receives the K toner sent from the agitator 43K.

The K toner received as just described is then supplied to the developing roller 42K through the contact portion between the toner supplying roller 44K and the developing roller 42K.

The K toner borne on the surface of the developing roller 42K serving as a developer bearing member is regulated in terms of its layer thickness and effectively subjected to frictional charging when passing through the position where it comes into contact with a regulating blade 45K, as the developing roller 42K is rotationally driven in the counterclockwise direction (in the drawing). Thereafter, the K toner is conveyed to a developing region that faces the latent electrostatic image bearing member (photoconductor) 3K.

### <Charging Member>

In view of adhesion of the toner, the charging member configured to recharge toner remaining on the surface of the latent electrostatic image bearing member after the transfer of images from the latent electrostatic image bearing member to a member in a subsequent step is preferably conductive because, if the charging member is insulative, the toner will adhere to it due to charge-up.

It is desirable that the charging member be a sheet made of a material selected from nylon, PTFE, PVDF and urethane. Particularly preferable among these are PTFE and PVDF in terms of chargeability of the toner.

The charging member preferably has a surface resistance of 10² Ω/sq. to 10⁸ Ω/sq. and a volume resistance of 10¹ Ω/sq. to 10⁶ Ω/sq.

The charging member is preferably in the form of a roller, a brush, a sheet, etc. In view of releasability of the attached toner, the charging member is particularly preferably in the form of a sheet.

In view of charging of the toner, the voltage applied to the charging member is preferably in the range of −1.4 kV to 0 kV.

In the case where the charging member is in the form of a conductive sheet, it is preferred (in view of the contact pressure between the charging member and the latent electrostatic image bearing member) that the thickness of the charging member be in the range of 0.05 mm to 0.5 mm.

Also, in view of the length of time of contact between the charging member and the latent electrostatic image bearing member when the toner is charged, it is preferred that the nip width (where the charging member is in contact with the latent electrostatic image bearing member) be in the range of 1 mm to 10 mm.

### (Image Forming Apparatus and Image Forming Method)

An image forming apparatus of the present invention includes: a latent image bearing member configured to bear a latent image; a charging unit configured to charge a surface of the latent image bearing member uniformly; an exposing unit configured to expose the charged surface of the latent image bearing member, based upon image data, so as to write a latent electrostatic image on the surface of the latent image bearing member; a developing unit configured to supply a toner to the latent electrostatic image formed on the surface of the latent image bearing member so as to make the latent electrostatic image into a visible image; a transfer unit configured to transfer the visible image on the surface of the latent image bearing member to a transfer target; and a fixing unit configured to fix the visible image on the transfer target. If necessary, the image forming apparatus may further include suitably selected other unit(s) such as a charge eliminating unit, a cleaning unit, a recycling unit, a controlling unit, etc.

An image forming method of the present invention includes the steps of uniformly charging a surface of a latent image bearing member; exposing the charged surface of the latent image bearing member, based upon image data, so as to write a latent electrostatic image on the surface of the latent image bearing member; forming a developer layer of a predetermined layer thickness over a developer bearing member by means of a developer layer regulating member, and developing the latent electrostatic image on the surface of the latent image bearing member with use of the developer layer so as to make the latent electrostatic image into a visible image; transferring the visible image on the surface of the latent image bearing member to a transfer target; and fixing the visible image on the transfer target. Note that the image forming method includes at least latent electrostatic image forming steps, the developing step, the transfer step and the fixing step, and may, if necessary, include suitably selected other step(s) such as a charge eliminating step, a cleaning step, a recycling step, a controlling step, etc.

The latent electrostatic image can be formed, for example, by uniformly charging the surface of the latent image bearing member by means of the charging unit and then exposing the surface imagewise by means of the exposing unit.

The formation of the visible image by the developing may specifically be as follows: a toner layer is formed on a developing roller serving as the developer bearing member, the toner layer on the developing roller is conveyed so as to come into contact with a photoconductor drum serving as the latent image bearing member, a latent electrostatic image on the photoconductor drum is thereby developed, and a visible image is thus formed.

The toner is agitated by an agitating unit and mechanically supplied to a developer supplying member.

The toner supplied from the developer supplying member and then deposited on the developer bearing member is formed into a uniform thin layer and charged, by passing through the developer layer regulating member provided in such a manner as to touch the surface of the developer bearing member.

The latent electrostatic image formed on the latent image bearing member is developed in a developing region by attachment of the charged toner thereto by means of the developing unit, and a toner image is thus formed.

For example, the visible image on the latent image bearing member (photoconductor) can be transferred by charging the latent image bearing member with the use of a transfer charger and can be transferred by the transfer unit.

The visible image transferred to a recording medium is fixed thereto using a fixing device. Toners of each color may be separately fixed upon their transfer to the recording medium. Alternatively, the toners of each color may be fixed at one time, being in a laminated state.

The fixing device is not particularly limited and may be suitably selected according to the intended purpose. Preference is given to a known heating and pressurizing unit.

Examples of the heating and pressurizing unit include a combination of a heating roller and a pressurizing roller, and a combination of a heating roller, a pressurizing roller and an endless belt.

In general, it is preferred that the temperature at which heating is performed by the heating and pressurizing unit be in the range of 80° C. to 200° C.

Next, the fundamental structure of an image forming apparatus (printer) according to an embodiment of the present invention will be further explained, referring to drawings.

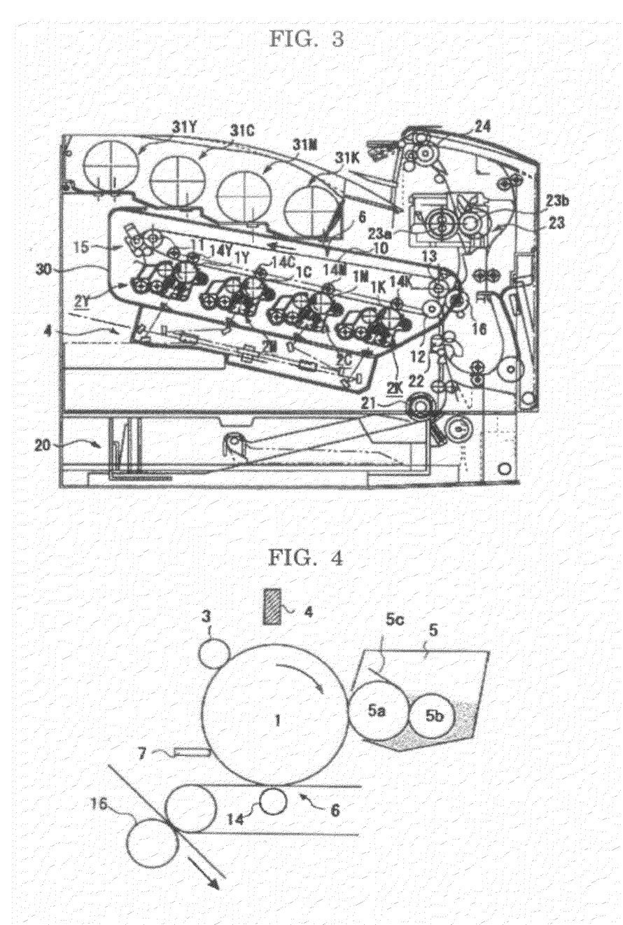

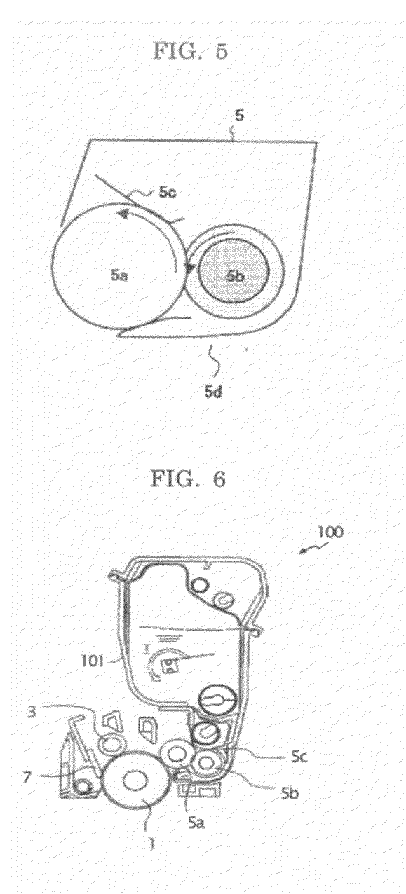

FIG. 3 is a schematic drawing showing the structure of an image forming apparatus according to an embodiment of the present invention.

Here, an embodiment in which the image forming apparatus is used as an electrophotographic image forming apparatus is explained.

The image forming apparatus forms a color image, using toners of four colors, i.e., yellow (hereinafter written as “Y”), cyan (hereinafter written as “C”), magenta (hereinafter written as “M”) and black (hereinafter written as “K”).

First of all, an explanation is given concerning the fundamental structure of an image forming apparatus (tandem-type image forming apparatus) including a plurality of latent image bearing members, wherein the latent image bearing members are aligned in the moving direction of a surface moving member.

This image forming apparatus includes four photoconductors 1Y, 1C, 1M and 1K as the latent image bearing members. Note that although drum-like photoconductors are employed here as an example, belt-like photoconductors may be employed instead.

The photoconductors 1Y, 1C, 1M and 1K are rotationally driven in the direction of the arrows in the drawing, coming into contact with an intermediate transfer belt 10 that serves as the surface moving member.

The photoconductors 1Y, 1C, 1M and 1K are each produced by forming a photosensitive layer over a relatively thin, cylindrical conductive substrate, and further, forming a protective layer over the photosensitive layer. Additionally, an intermediate layer may be provided between the photosensitive layer and the protective layer.

FIG. 4 is a schematic drawing showing the structure of an image forming unit 2 in which a photoconductor is placed.

In FIG. 4, only one image forming unit 2 is shown and the symbols Y, C, M and K for referring to differences in color are omitted, on the grounds that the structures of the photoconductors 1Y, 1C, 1M and 1K and their surroundings in image forming units 2Y, 2C, 2M and 2K respectively are identical.

Around the photoconductor 1, the following members are disposed in the order mentioned, with respect to the direction in which the surface of the photoconductor 1 moves: a charging device 3 as the charging unit, a developing device 5 as the developing unit, a transfer device 6 as the transfer unit configured to transfer a toner image on the photoconductor 1 to a recording medium or the intermediate transfer belt 10, and a cleaning device 7 configured to remove untransferred toner on the photoconductor 1.

Between the charging device 3 and the developing device 5, there is a space created such that light emitted from an exposing device 4 (which serves as the exposing unit configured to expose the charged surface of the photoconductor 1, based upon image data, so as to write a latent electrostatic image on the surface of the photoconductor 1) can pass through and reach as far as the photoconductor 1.

The charging device 3 charges the surface of the photoconductor 1 such that the surface has negative polarity.

The charging device 3 in the present embodiment includes a charging roller serving as a charging member which performs charging in accordance with a contact or close-distance charging method.

Specifically, this charging device 3 charges the surface of the photoconductor 1 by placing the charging roller so as to be in contact with or close to the surface of the photoconductor 1, and applying a bias of negative polarity to the charging roller.

Such a direct-current charging bias as makes the photoconductor 1 have a surface potential of −500 V is applied to the charging roller.

Additionally, a charging bias produced by superimposing an alternating-current bias onto a direct-current bias may be used as well.

The charging device 3 may be provided with a cleaning brush for cleaning the surface of the charging roller.

Also regarding the charging device 3, a thin film may be wound around both ends (with respect to the axial direction) on the circumferential surface of the charging roller, and this film may be placed so as to touch the surface of the photoconductor 1.

In this structure, the surface of the charging roller and the surface of the photoconductor 1 are very close to each other, with the distance between them being equivalent to the thickness of the film. Thus, electric discharge is generated between the surface of the charging roller and the surface of the photoconductor 1 by the charging bias applied to the charging roller, and the surface of the photoconductor 1 is charged by means of the electric discharge.

The surface of the photoconductor 1 thus charged is exposed by the exposing device 4, and a latent electrostatic image corresponding to each color is formed on the surface of the photoconductor 1.

This exposing device 4 writes a latent electrostatic image (which corresponds to each color) on the surface of the photoconductor 1 based upon image information (which corresponds to each color).

Note that although the exposing device 4 in the present embodiment is of laser type, an exposing device of other type, which includes an LED array and an image forming unit, may be employed as well.

Each toner supplied from toner bottles 31Y, 31C, 31M and 31K into the developing device 5 is conveyed by a developer supplying roller 5b and then borne on a developing roller 5a.

This developing roller 5a is conveyed to a region that faces the photoconductor 1 (hereinafter, this region will be referred to as “developing region”).

In the developing region, the surface of the developing roller 5a moves in the same direction as and at a higher linear velocity than the surface of the photoconductor 1.

Then, the toner on the developing roller 5a is supplied onto the surface of the photoconductor 1, rubbing against the surface of the photoconductor 1. At this time, a developing bias of −300V is applied from a power source (not shown) to the developing roller 5a, and thus a developing electric field is formed in the developing region.

Between the latent electrostatic image on the photoconductor 1 and the developing roller 5a, electrostatic force which advances toward the latent electrostatic image acts on the toner borne on the developing roller 5a.

Thus, the toner on the developing roller 5a is attached to the latent electrostatic image on the photoconductor 1. By this attachment, the latent electrostatic image on the photoconductor 1 is developed into a toner image corresponding to each color.

The intermediate transfer belt 10 in the transfer device 6 is set in a stretched manner on three supporting rollers 11, 12 and 13 and is configured to move endlessly in the direction of the arrow in the drawing.

The toner images on the photoconductors 1Y, 1C, 1M and 1K are transferred by an electrostatic transfer method onto this intermediate transfer belt 10 such that the toner images are superimposed on one another.

The electrostatic transfer method may employ a structure with a transfer charger. Nevertheless, in this embodiment, a structure with a primary transfer roller 14, which causes less scattering of transferred toner, is employed.

Specifically, primary transfer rollers 14Y, 14C, 14M and 14K each serving as a component of the transfer device 6 are placed on the opposite side to the part of the intermediate transfer belt 10 which comes into contact with the photoconductors 1Y, 1C, 1M and 1K.

Here, the part of the intermediate transfer belt 10 pressed by the primary transfer rollers 14Y, 14C, 14M and 14K, and the photoconductors 1Y, 1C, 1M and 1K constitute respective primary transfer nip portions.

When the toner images on the photoconductors 1Y, 1C, 1M and 1K are transferred onto the intermediate transfer belt 10, a bias of positive polarity is applied to each primary transfer roller 14.

Accordingly, a transfer electric field is formed at each primary transfer nip portion, and the toner images on the photoconductors 1Y, 1C, 1M and 1K are electrostatically attached onto the intermediate transfer belt 10 and thus transferred.

A belt cleaning device 15 for removing toner which remains on the surface of the intermediate transfer belt 10 is provided in the vicinity of the intermediate transfer belt 10.

Using a fur brush or a cleaning blade, this belt cleaning device 15 is configured to collect unnecessary toner attached to the surface of the intermediate transfer belt 10.

Parenthetically, the collected unnecessary toner is conveyed from inside the belt cleaning device 15 to a waste toner tank (not shown) by a conveyance unit (not shown).

At the part where the intermediate transfer belt 10 is set in a stretched manner on the supporting roller 13, a secondary transfer roller 16 is placed so as to be in contact with the intermediate transfer belt 10.

A secondary transfer nip portion is formed between the intermediate transfer belt 10 and the secondary transfer roller 16, and transfer paper as a recording medium is sent to this secondary transfer nip portion with predetermined timing.

This transfer paper is stored in a paper feed cassette 20 situated below (in the drawing) the exposing device 4, then the transfer paper is transferred to the secondary transfer nip portion by a paper feed roller 21, a pair of registration rollers 22 and the like.

At the secondary transfer nip portion, the toner images superimposed onto one another on the intermediate transfer belt 10 are transferred onto the transfer paper at one time.

At the time of this secondary transfer, a bias of positive polarity is applied to the secondary transfer roller 16, and the toner images on the intermediate transfer belt 10 are transferred onto the transfer paper by means of a transfer electric field formed by the application of the bias.

A heat fixing device 23 serving as the fixing unit is placed downstream of the secondary transfer nip portion with respect to the direction in which the transfer paper is conveyed.

This heat fixing device 23 includes a heating roller 23a with a heater incorporated therein, and a pressurizing roller 23b for applying pressure.

The transfer paper which has passed through the secondary transfer nip portion receives heat and pressure, sandwiched between these rollers. This causes the toners on the transfer paper to melt, and a toner image is fixed to the transfer paper. The transfer paper to which the toner image has been fixed is discharged by a paper discharge roller 24 onto a paper discharge tray situated on an upper surface of the apparatus.

Regarding the developing device 5, the developing roller 5a serving as the developer bearing member is partially exposed from an opening of a casing of the developing device 5.

Also, in this embodiment, a one-component developer including no carrier is used.

The developing device 5 receives the toner (which corresponds to each color) supplied from the toner bottles 31Y, 31C, 31M and 31K (shown in FIG. 3) and stores it therein.

These toner bottles 31Y, 31C, 31M and 31K are detachably mounted to the main body of the image forming apparatus such that they can be separately replaced.

Due to such a structure, when any of the toners has run out, the corresponding toner bottle among the toner bottles 31Y, 31C, 31M and 31K can be replaced independently. Therefore, when any of the toners has run out, components other than the corresponding toner bottle, whose lifetimes have not yet ended, can continue being used, and thus the user can save costs.

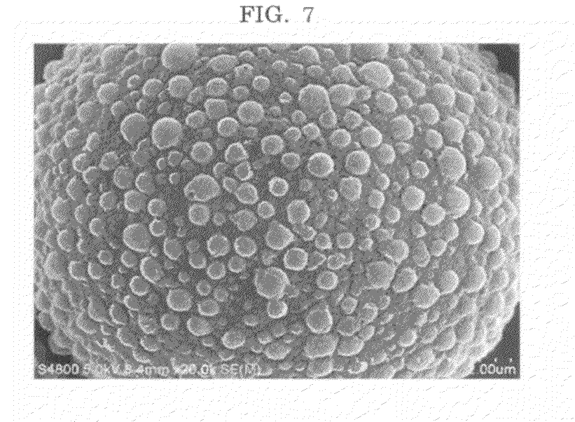

FIG. 6 is a schematic drawing showing the structure of the developing device 5 shown in FIG. 4.

The developer (toner) housed in a developer storing container is conveyed to a nip portion formed between the developing roller 5a (which serves as the developer bearing member configured to bear on its surface the developer to be supplied to the photoconductor 1) and the developer supplying roller 5b (which serves as the developer supplying member) while being agitated by the developer supplying roller 5b. At this time, the developer supplying roller 5b and the developing roller 5a rotate in opposite directions to each other (counter rotation) at the nip portion. The amount of the toner on the developing roller 5a is regulated by a regulating blade 5c (which serves as the developer layer regulating member) provided so as to touch the developing roller 5a, and a toner thin layer is thus formed on the developing roller 5a.

Also, the toner is rubbed at the nip portion between the developer supplying roller 5b and the developing roller 5a and at the part between the regulating blade 5c and the developing roller 5a, and controlled so as to have an appropriate charge amount.

FIG. 6 is a schematic drawing showing the structure of a process cartridge.

The developer according to the present invention can be used, for example, in an image forming apparatus provided with a process cartridge 100 shown in FIG. 6.

In the present invention, among components such as a latent electrostatic image bearing member, a latent electrostatic image charging unit and a developing unit, a plurality of members constitute a single unit as a process cartridge, and this process cartridge is constructed in such a manner as to be detachably mountable to the main body of an image forming apparatus such as a copier or printer.

The process cartridge 100 shown in FIG. 6 includes a latent electrostatic image bearing member, a latent electrostatic image charging unit, and the developing unit explained in relation to FIG. 6. In FIG. 6, the sign 101 denotes a developer storing container.

The toner particles of the present invention preferably have a volume average particle diameter of 3 μm to 9 μm, preferably 4 μm to 8 μm, more preferably 4 μm to 7 μm, in order for the toner particles to be changed uniformly and sufficiently. The toner particles having a volume average particle diameter less than 3 μm are relatively increased in toner adhesion force, which is not preferred since the toner operability is reduced under an electrical field. The toner particles having a volume average particle diameter exceeding 9 μm form an image whose image qualities (e.g., reproducibility of thin lines) are degraded.

Also, in the toner, the ratio of the volume average particle diameter to the number average particle diameter (volume average particle diameter Dv/number average particle diameter Dp) of the toner particles is preferably 1.25 or less, more preferably 1.20 or less, still more preferably 1.17 or less. When the ratio therebetween exceeds 1.25; i.e., the toner particles have low uniformity in particle diameter, the size of the protrusions tends to be varied. In addition, during repetitive use, toner particles having a large particle diameter or, in some cases, toner particles having small particle diameter are preferentially consumed, so that the average particle diameter of the toner particle remaining in the developing device is changed from that of the toner particles at an initial state. Thus, the developing conditions initially set are not optimal for development of the remaining toner particles. As a result, various unfavorable phenomena tend to occur including charging failure, considerable increase or decrease of the amount of toner particles conveyed, toner clogging and toner leakage.

Employable measurement apparatus for the particle size distribution of the toner particles includes a Coulter Counter TA-II and Coulter Multisizer II (these products are of Coulter, Inc.). The measurement method will next be described.

First, a surfactant (0.1 mL to 5 mL), preferably an alkylbenzene sulfonic acid salt, is added as a dispersing agent to an electrolyte solution (100 mL to 150 mL). Here, the electrolyte solution is a 1% aqueous NaCl solution prepared using 1st grade sodium chloride, and examples of commercially available products thereof include ISOTON-II (product of Coulter, Inc.). Subsequently, a measurement sample (2 mg to 20 mg) is suspended in the above-obtained electrolyte solution. The resultant electrolyte solution is dispersed with an ultrasonic wave disperser for about 1 min to about 3 min. The thus-obtained dispersion liquid is analyzed with the above-described apparatus using an aperture of 100 μm to measure the number or volume of the toner particles. Then, the volume particle size distribution and number particle size distribution are calculated from the obtained values. From these distributions, the volume average particle diameter, Dv, and number average particle diameter, Dp, of the toner can be obtained.

Notably, in this measurement, 13 channels are used: 2.00 μm (inclusive) to 2.52 μm (exclusive); 2.52 μm (inclusive) to 3.17 μm (exclusive); 3.17 μm (inclusive) to 4.00 μm (exclusive); 4.00 μm (inclusive) to 5.04 μm (exclusive); 5.04 μm (inclusive) to 6.35 μm (exclusive); 6.35 μm (inclusive) to 8.00 μm (exclusive); 8.00 μm (inclusive) to 10.08 μm (exclusive); 10.08 μm (inclusive) to 12.70 μm (exclusive); 12.70 μm (inclusive) to 16.00 μm (exclusive); 16.00 μm (inclusive) to 20.20 μm (exclusive); 20.20 μm (inclusive) to 25.40 μm (exclusive); 25.40 μm (inclusive) to 32.00 μm (exclusive); and 32.00 μm (inclusive) to 40.30 μm (exclusive); i.e., particles having a particle diameter of 2.00 μm (inclusive) to 40.30 μm (exclusive) are subjected to the measurement.

The toner has an average sphericity of 0.930 or more, preferably 0.950 or more, more preferably 0.970 or more. The toner having an average sphericity less than 0.930 is poor in flowability to easily cause failures upon development as well as to be degraded in transfer efficiency.

The average sphericity of the toner can be measured using a flow-type particle image analyzer FPIA-2000. Specifically, 0.1 mL to 0.5 mL of a surfactant (preferably an alkylbenzene sulfonic acid salt) is added as a dispersing agent into 100 mL to 150 mL of water in a container, from which solid impurities have previously been removed. Then, about 0.1 g to about 0.5 g of a measurement sample is added to the container, followed by dispersing. The resultant suspension is subjected to dispersing treatment by an ultrasonic disperser for 1 min to 3 min, and the concentration of the dispersion liquid is adjusted such that the number of particles of the sample is 3,000 per microliter to 10,000 per microliter. In this state, the shape and distribution of the toner are measured using the analyzer.

In the case of the toner produced by the wet granulation method, ionic toner materials are localized in the vicinity of the surface of the toner. As a result, the surface layer of the toner is relatively low in resistance to improve the toner in charging speed and charge rising property. However, such toner has poor charge retentability; in other words, it is easy for the charge amount of the toner to rapidly decrease. The method for improving this problem is, for example, a method in which a surface modifier is allowed to be supported on the surface of the toner.

### <Measurement of Particle Diameter of Resin Particles>

The particle diameter of the resin particles, which forms the protrusions of the toner of the present invention, can be measured using UPA-150EX (product of NIKKISO CO., LTD.).

The resin particles have a particle diameter of 50 nm to 200 nm, preferably 80 nm to 160 nm, more preferably 100 nm to 140 nm. When the particle diameter is smaller than 50 nm, it is difficult to form sufficiently large protrusions on the toner surface. When the particle diameter exceeds 200 nm, the formed protrusions become ununiform, which is not preferred. Also, in the resin particles, the ratio of the volume average particle diameter to the number average particle diameter (volume average particle diameter/number average particle diameter) is preferably 1.25 or less, more preferably 1.20 or less, still more preferably 1.17 or less. When the volume average particle diameter/number average particle diameter exceeds 1.25; i.e., the resin particles are poor in uniformity of particle diameter, the size of the protrusions tend to be varied.

### <Measurement of Molecular Weight by GPC>

The molecular weight of the resin was measured through gel permeation chromatography (GPC) under the following conditions.

Apparatus: GPC-150C (product of Waters Co.)
Column: KF801 to 807 (product of Shodex Co.)

### Temperature: 40° C.

Solvent: THF (tetrahydrofuran)
Flow rate: 1.0 mL/min
Sample injected: 0.1 mL of a sample having a concentration of 0.05% to 0.6%

From the molecular weight distribution of the resin measured under the above conditions, the number average molecular weight and the weight average molecular weight of the resin were calculated using a molecular weight calibration curve obtained from monodispersed polystyrene standard samples. The standard polystyrene samples used for obtaining the calibration curve were toluene and Std. Nos. S-7300, S-210, S-390, S-875, S-1980, S-10.9, S-629, S-3.0 and S-0.580 of Showdex STANDARD (product of SHOWA DENKO K.K.). The detector used was a RI (refractive index) detector.

### <Measurement of Glass Transition Temperature (Tg) (DSC)>

The Tg was measured using TG-DSC system TAS-100 (product of Rigaku Denki Co., Ltd.).

A sample (about 10 mg) is placed in an aluminum container, which is placed on a holder unit. The holder unit is then set in an electric oven. The sample is heated from room temperature to 150° C. at a temperature increasing rate of 10° C./min, left to stand at 150° C. for 10 min, cooled to room temperature, and left to stand for 10 min. In a nitrogen atmosphere, the sample is heated again to 150° C. at a temperature increasing rate of 10° C./min for DSC analysis. Using the analysis system of TAS-100 system, the Tg is calculated from the tangent point between the base line and the tangential line of the endothermic curve near the Tg.

### <Measurement of Concentration of Solid Matter>

The concentration of solid matter contained in the oil phase was measured as follows.

An aluminum plate (about 1 g to about 3 g) is accurately weighed in advance. About 2 g of the oil phase is placed on the aluminum plate within 30 sec, and then the oil phase placed thereon is accurately weighed. The aluminum plate is placed for 1 hour in an oven set to 150° C. to evaporate the solvent. Thereafter, the aluminum plate is taken out from the oven and left to cool. Subsequently, the total mass of the aluminum plate and solid matter of the oil phase is measured with an electronic balance. The mass of the aluminum plate is subtracted from the total mass of the aluminum plate and the solid matter contained in the oil phase to obtain the mass of the solid matter contained in the oil phase, which is divided by the mass of the oil phase placed on the aluminum plate to obtain the concentration of the solid matter contained in the oil phase. Also, the ratio of the solvent to the solid matter contained in the oil phase is a value obtained from the following: (the mass of the oil phase−the mass of the solid matter contained in the oil phase); i.e., the mass of the solvent/the mass of the solid matter contained in the oil phase.

### <Measurement of Acid Value of Resin>

The acid value of the resin is measured according to JIS K1557-1970, which will be specifically described below.

About 2 g of a pulverized sample is accurately weighed (W (g)).

The sample is added to a 200 mL conical flask. Then, 100 mL of a solvent mixture of toluene/ethanol (2:1) is added to the flask. The resultant mixture is left to stand for 5 hours for dissolution. A phenolphthalein solution serving as an indicator is added to the solution.

The resultant solution is titrated with 0.1N alcohol solution of potassium hydroxide using a buret. The amount of the KOH solution is defined as S (mL). A blank test is performed, and the amount of the KOH solution is defined as B (mL).

The acid value is calculated using the following equation:

Acid value=[(S−B)×f×5.61]/W

where f denotes a factor of the KOH solution.

### <As to Long Side and Coverage Rate of Protrusions>

The toner particles are observed under a scanning electron microscope (SEM). The obtained SEM image is used to measure lengths of long sides of the protrusions of each toner particle and a coverage rate of the protrusions on each toner particle.

Below, referring to FIG. 1, description will be given to the calculation methods for long sides and coverage rate of the protrusions described in Examples.

### <<Coverage Rate>>

The shortest length between two parallel straight lines in contact with the toner particle is determined, and the contact points are defined as A and B.

The area of a circle having as a center the center O of the line segment AB and having as a diameter the length of the line segment AO is calculated. The total area of the protrusions contained in the circle is calculated to obtain a coverage rate of the protrusions on the toner particle (i.e., the total area of the protrusions/the area of the circle).

One hundred or more toner particles are calculated for coverage rate with the above method, and then an average value thereof is determined

### <<Average Length of the Long Sides>>

The average length of the long sides is obtained by measuring the lengths of the long sides of 100 or more protrusions on 100 or more toner particles.

In Examples, 100 toner particles were selected. The length of the long side of one protrusion was measured on each toner particle of the selected 100 toner particles and the lengths measured were averaged.

The area of the protrusions and the long side of the protrusions were measured with an image analysis-type particle size distribution analyzing software “MAC-VIEW” (product of Mountech Co., Ltd.).

The measuring methods for the length of the long side of the protrusion and the area of the protrusion are not particularly limited and may be appropriately selected depending on the intended purpose.

The average of the lengths of the long sides of the protrusions is 0.1 μm to 0.5 μm, preferably 0.1 μm to 0.30 μm. When it is greater than 0.5 μm, the protrusions on the surface become sparse and surface modification cannot exert a sufficient effect. The standard deviation of the average of the lengths of the long sides of the protrusions is 0.20 or less, preferably 0.10 or less. When it is more than 0.20, the size of the protrusions on the surface becomes ununiform and the surface area is not expected to increase, which is not preferred. The coverage rate is 30% to 90%, preferably 40% to 80%, more preferably 50% to 70%. The coverage rate of less than 30% leads to background smear and low heat resistance storage stability. The coverage rate of more than 90% results in the deterioration of low-temperature fixing property.

### EXAMPLES

The present invention will next be described in more detail by way of Examples and Comparative Examples. The present invention is not construed as being limited thereto. The unit “part(s)” means “part(s) by mass.”

The properties of toners, average molecular weight of resins, acid value of resins, volume average particle diameter of resin particles, long side and coverage rate of protrusions, etc. in Example were measured as described above.

### <Preparation Method of Resin Dispersion Liquid 1>

A reaction container equipped with a condenser, a stirrer and a nitrogen-introducing pipe was charged with styrene monomer (190 parts), butyl acrylate (4 parts), acrylamide-2-methylpropanesulfonic acid (6 parts) (product of Wako Pure Chemical Industries, Ltd.), acetone (60 parts), and 2,2′-azobis(2,4-dimethylvaleronitrile) (4 parts). The mixture was increased in temperature to 60° C. in a nitrogen atmosphere to perform polymerization reaction for 10 hours. Subsequently, the temperature of the mixture was increased to 150° C. and then, the reaction mixture was cooled to room temperature. Acetone was again added so as to adjust the concentration of solid matter to 76%. Then, a solution of sodium dodecyl sulfate (1.2 parts) in ion-exchange water (610 parts) was added to the resultant solution. The mixture was emulsified by stirring with a TK homomixer. Acetone was removed with a rotary evaporator from the obtained emulsion liquid to obtain white Resin Dispersion Liquid 1 having a volume average particle diameter of 120 nm.

### <Preparation Method of Resin Dispersion Liquid 2>

A reaction container equipped with a condenser, a stirrer and a nitrogen-introducing pipe was charged with styrene monomer (190 parts), butyl acrylate (9 parts), acrylamide-2-methylpropanesulfonic acid (1 part) (product of Wako Pure Chemical Industries, Ltd.), acetone (60 parts), and 2,2′-azobis(2,4-dimethylvaleronitrile) (4 parts). The mixture was increased in temperature to 60° C. in a nitrogen atmosphere to perform polymerization reaction for 10 hours. Subsequently, the temperature of the mixture was increased to 150° C. and then, the reaction mixture was cooled to room temperature. Acetone was again added so as to adjust the concentration of solid matter to 76%. Then, a solution of sodium dodecyl sulfate (1.2 parts) in ion-exchange water (610 parts) was added to the resultant solution. The mixture was emulsified by stirring with a TK homomixer. Acetone was removed with a rotary evaporator from the obtained emulsion liquid to obtain white Resin Dispersion Liquid 2 having a volume average particle diameter of 122 nm.

### <Preparation Method of Resin Dispersion Liquid 3>

A reaction container equipped with a condenser, a stirrer and a nitrogen-introducing pipe was charged with styrene monomer (190 parts), acrylamide-2-methylpropanesulfonic acid (10 parts) (product of Wako Pure Chemical Industries, Ltd.), acetone (60 parts), and 2,2′-azobis(2,4-dimethylvaleronitrile) (4 parts). The mixture was increased in temperature to 60° C. in a nitrogen atmosphere to perform polymerization reaction for 10 hours. Subsequently, the temperature of the mixture was increased to 150° C. and then, the reaction mixture was cooled to room temperature. Acetone was again added so as to adjust the concentration of solid matter to 76%. Then, a solution of sodium dodecyl sulfate (1.2 parts) in ion-exchange water (610 parts) was added to the resultant solution. The mixture was emulsified by stirring with a TK homomixer. Acetone was removed with a rotary evaporator from the obtained emulsion liquid to obtain white Resin Dispersion Liquid 3 having a volume average particle diameter of 120 nm.

### <Preparation Method of Resin Dispersion Liquid 4>

A reaction container equipped with a condenser, a stirrer and a nitrogen-introducing pipe was charged with styrene monomer (180 parts), butyl acrylate (14 parts), acrylamide-2-methylpropanesulfonic acid (6 parts) (product of Wako Pure Chemical Industries, Ltd.), acetone (60 parts), and 2,2′-azobis(2,4-dimethylvaleronitrile) (4 parts). The mixture was increased in temperature to 60° C. in a nitrogen atmosphere to perform polymerization reaction for 10 hours. Subsequently, the temperature of the mixture was increased to 150° C. and then, the reaction mixture was cooled to room temperature. Acetone was again added so as to adjust the concentration of solid matter to 76%. Then, a solution of sodium dodecyl sulfate (1.2 parts) in ion-exchange water (610 parts) was added to the resultant solution. The mixture was emulsified by stirring with a TK homomixer. Acetone was removed with a rotary evaporator from the obtained emulsion liquid to obtain white Resin Dispersion Liquid 4 having a volume average particle diameter of 127 nm.

### <Preparation Method of Resin Dispersion Liquid 5>

A reaction container equipped with a condenser, a stirrer and a nitrogen-introducing pipe was charged with styrene monomer (200 parts), acetone (60 parts), and 2,2′-azobis(2,4-dimethylvaleronitrile) (4 parts). The mixture was increased in temperature to 60° C. in a nitrogen atmosphere to perform polymerization reaction for 10 hours. Subsequently, the temperature of the mixture was increased to 150° C. and then, the reaction mixture was cooled to room temperature. Acetone was again added so as to adjust the concentration of solid matter to 76%. Then, a solution of sodium dodecyl sulfate (1.2 parts) in ion-exchange water (610 parts) was added to the resultant solution. The mixture was emulsified by stirring with a TK homomixer. Acetone was removed with a rotary evaporator from the obtained emulsion liquid to obtain white Resin Dispersion Liquid 5 having a volume average particle diameter of 116 nm.

### <Preparation Method of Resin Dispersion Liquid 6>

A reaction container equipped with a condenser, a stirrer and a nitrogen-introducing pipe was charged with styrene monomer (160 parts), butyl acrylate (34 parts), acrylamide-2-methylpropanesulfonic acid (6 parts) (product of Wako Pure Chemical Industries, Ltd.), acetone (60 parts), and 2,2′-azobis(2,4-dimethylvaleronitrile) (4 parts). The mixture was increased in temperature to 60° C. in a nitrogen atmosphere to perform polymerization reaction for 10 hours. Subsequently, the temperature of the mixture was increased to 150° C. and then, the reaction mixture was cooled to room temperature. Acetone was again added so as to adjust the concentration of solid matter to 76%. Then, a solution of sodium dodecyl sulfate (1.2 parts) in ion-exchange water (610 parts) was added to the resultant solution. The mixture was emulsified by stirring with a TK homomixer. Acetone was removed with a rotary evaporator from the obtained emulsion liquid to obtain white Resin Dispersion Liquid 6 having a volume average particle diameter of 119 nm.

### <Preparation Method of Resin Dispersion Liquid 7>

A reaction container equipped with a condenser, a stirrer and a nitrogen-introducing pipe was charged with styrene monomer (180 parts), acrylamide-2-methylpropanesulfonic acid (20 parts) (product of Wako Pure Chemical Industries, Ltd.), acetone (60 parts), and 2,2′-azobis(2,4-dimethylvaleronitrile) (4 parts). The mixture was increased in temperature to 60° C. in a nitrogen atmosphere to perform polymerization reaction for 10 hours. Subsequently, the temperature of the mixture was increased to 150° C. and then, the reaction mixture was cooled to room temperature. Acetone was again added so as to adjust the concentration of solid matter to 76%. Then, a solution of sodium dodecyl sulfate (1.2 parts) in ion-exchange water (610 parts) was added to the resultant solution. The mixture was emulsified by stirring with a TK homomixer. Acetone was removed with a rotary evaporator from the obtained emulsion liquid to obtain white Resin Dispersion Liquid 7 having a volume average particle diameter of 126 nm.

### <Preparation Method of Resin Dispersion Liquid 8>

A reaction container equipped with a condenser, a stirrer and a nitrogen-introducing pipe was charged with sodium dodecyl sulfate (0.7 parts) and ion-exchange water (498 parts), followed by heating to 80° C. under stirring for dissolution. Then, a solution of potassium persulfate (2.5 parts) in ion-exchange water (100 parts) was added to the resultant solution. Fifteen minutes after the addition, a monomer mixture of a styrene monomer (170 parts), butyl acrylate (24 parts), p-styrene sulfonate ethyl ester (6 parts), and n-octanethiol (4.1 parts) was added dropwise to the resultant mixture for 90 min. Subsequently, the temperature of the mixture was maintained at 80° C. for 60 min to perform polymerization reaction.

Then, the reaction mixture was cooled to obtain white Resin Dispersion Liquid 8 having a volume average particle diameter of 135 nm. Subsequently, 2 mL of the thus-obtained dispersion liquid was added to a Petri dish, where the dispersion medium was evaporated. The obtained dry product was measured for number average molecular weight and weight average molecular weight, which were found to be 8,200 and 19,200, respectively.

### <Preparation Method of Resin Dispersion Liquid 9>

Sodium p-styrenesulfonate (2 parts) was added to ion-exchange water (78 parts) and dissolved to prepare an aqueous solution of sodium p-styrenesulfonate. Separately, a reaction container equipped with a condenser, a stirrer and a nitrogen-introducing pipe was charged with sodium dodecyl sulfate (0.7 parts) and ion-exchange water (420 parts), followed by heating to 80° C. under stirring for dissolution. Then, a solution of potassium persulfate (2.5 parts) in ion-exchange water (101 parts) was added to the resultant solution. Fifteen minutes after the addition, a monomer mixture of a styrene monomer (178 parts), butyl acrylate (20 parts), and n-octanethiol (4.1 parts) and the aqueous solution of sodium p-styrenesulfonate were simultaneously added dropwise to the resultant mixture for 90 min. Subsequently, the temperature of the mixture was maintained at 80° C. for 60 min to perform polymerization reaction.

Then, the reaction mixture was cooled to obtain white Resin Dispersion Liquid 9 having a volume average particle diameter of 135 nm. Subsequently, 2 mL of the thus-obtained dispersion liquid was added to a Petri dish, where the dispersion medium was evaporated. The obtained dry product was measured for number average molecular weight and weight average molecular weight, which were found to be 8,400 and 19,900, respectively.

### <Synthesis of Polyester 1>

A reaction container equipped with a condenser, a stirrer and a nitrogen-introducing pipe was charged with bisphenol A ethylene oxide 2 mol adduct (553 parts), bisphenol A propylene oxide 2 mol adduct (196 parts), terephthalic acid (220 parts), adipic acid (45 parts) and dibutyl tin oxide (2 parts), followed by reaction at 230° C. for 8 hours under normal pressure. Next, the reaction mixture was allowed to react for 5 hours under a reduced pressure of 10 mmHg to 15 mmHg. Then, trimellitic anhydride (46 parts) was added to the reaction container, followed by reaction at 180° C. for 2 hours under normal pressure, to thereby obtain Polyester 1. Polyester 1 was found to have a number average molecular weight of 2,200, a weight average molecular weight of 5,600, a glass transition temperature, Tg, of 43° C. and an acid value of 13 mgKOH/g.

### <Synthesis of Polyester 2>

A reaction container equipped with a condenser, a stirrer and a nitrogen-introducing pipe was charged with bisphenol A ethylene oxide 2 mol adduct (218 parts), bisphenol A propylene oxide 2 mol adduct (460 parts), terephthalic acid (140 parts), isophthalic acid (145 parts) and dibutyl tin oxide (2 parts), followed by reaction at 230° C. for 8 hours under normal pressure. Next, the reaction mixture was allowed to react for 6 hours under a reduced pressure of 10 mmHg to 18 mmHg. Then, trimellitic anhydride (24 parts) was added to the reaction container, followed by reaction at 180° C. for 2 hours under normal pressure, to thereby obtain Polyester 2. Polyester 2 was found to have a number average molecular weight of 7,600, a weight average molecular weight of 21,000, a glass transition temperature, Tg, of 57° C. and an acid value of 15 mgKOH/g.

### <Synthesis of Prepolymer>

A reaction container equipped with a condenser, a stirrer and a nitrogen-introducing pipe was charged with bisphenol A ethylene oxide 2 mol adduct (682 parts), bisphenol A propylene oxide 2 mol adduct (81 parts), terephthalic acid (283 parts), trimellitic anhydride (22 parts) and dibutyl tin oxide (2 parts), followed by reaction at 230° C. for 8 hours under normal pressure. Next, the reaction mixture was allowed to react for 5 hours under a reduced pressure of 10 mmHg to 15 mmHg to obtain Intermediate Polyester 1. Intermediate Polyester 1 was found to have a number average molecular weight of 2,100, a weight average molecular weight of 9,500, a glass transition temperature, Tg, of 55° C., an acid value of 0.5 mgKOH/g and a hydroxyl group value of 49 mgKOH/g.

Subsequently, a reaction container equipped with a condenser, a stirrer, and a nitrogen-introducing pipe was charged with Intermediate Polyester 1 (411 parts), isophorone diisocyanate (89 parts), ethyl acetate (500 parts), allowing the resultant mixture to react for 5 hours at 100° C. to thereby obtain Prepolymer 1. Prepolymer 1 thus obtained had a free isocyanate content of 1.53% by mass.

### <Synthesis of Masterbatch>

Carbon black (40 parts) (REGAL 400R, product of Cabot Corporation), polyester resin (60 parts) (RS-801, product of Sanyo Chemical Industries, Ltd., acid value: 10 mgKOH/g, weight average molecular weight, Mw: 20,000, glass transition temperature, Tg: 64° C.) as a binder resin and water (30 parts) were mixed together using HENSCHEL MIXER, to thereby obtain a mixture containing pigment aggregates impregnated with water. The obtained mixture was kneaded for 45 min with a two-roll mill whose roll surface temperature had been adjusted to 130° C. The kneaded product was pulverized with a pulverizer so as to have a size of 1 mm in diameter, whereby Masterbatch 1 was obtained.

### Example 1

### Preparation of Aqueous Phase

Ion-exchange water (963 parts), 88 parts of 25% aqueous dispersion liquid of organic resin particles for stabilizing dispersion (a copolymer of styrene-methacrylic acid-butyl acrylate-sodium salt of methacrylic acid ethylene oxide adduct sulfuric acid ester), 80 parts of 48.5% aqueous solution of sodium dodecyl diphenyl ether disulfonate (Eleminol MON-7, product of Sanyo Chemical Industries Ltd.) and 113 parts of ethyl acetate were mixed together under stirring to obtain a milky white liquid. This liquid is referred to as Aqueous Phase 1.

### Preparation of Pigment/Wax Dispersion Liquid

### Oil Phase

A container to which a stirring rod and a thermometer had been set was charged with Polyester 1 (378 parts), paraffin wax (HNP9, product of NIPPON SEIRO CO., Ltd.) (120 parts) and ethyl acetate (1,450 parts). The mixture was increased in temperature to 80° C. under stirring, maintained at 80° C. for 5 hours, and cooled to 30° C. for 1 hour. Then, the container was charged with Masterbatch 1 (500 parts) and ethyl acetate (500 parts), followed by mixing for 1 hour, to thereby obtain Raw Material Solution 1.

Raw Material Solution 1 (1,500 parts) was placed in a container, where carbon black and the wax were dispersed with a bead mill (“ULTRA VISCOMILL,” product of AIMEX CO., Ltd.) under the following conditions: a liquid feed rate of 1 kg/hr, disc circumferential velocity of 6 m/s, zirconia beads of 0.5 mm in diameter packed to 80% by volume, and 3 passes. Next, a 65% by mass ethyl acetate solution of Polyester 1 (655 parts) was added thereto, and passed once with the bead mill under the above conditions, to thereby obtain Pigment/Wax Dispersion Liquid 1. Ethyl acetate was added so that the concentration of solid matter (130° C., 30 min) of Pigment/Wax Dispersion Liquid 1 was adjusted to 50%.

### Emulsifying Step

Pigment/Wax Dispersion Liquid 1 (976 parts) was mixed with isophorondiamine (6 parts) as an amine for 1 min at 5,000 rpm with a TK homomixer (product of Tokushu Kika Kogyo Co., Ltd.). Then, Prepolymer 1 (137 parts) was added to the mixture. The resultant mixture was mixed for 1 min at 5,000 rpm with a TK homomixer (product of Tokushu Kika Kogyo Co., Ltd.), followed by the addition of Aqueous Phase 1 (1,200 parts). The mixture was mixed for 20 minutes with a TK homomixer while adjusting the rotation speed to from 8,000 rpm to 13,000 rpm to thereby obtain Emulsified Slurry 1.

### Protrusion Formation Step

To a container equipped with a stirrer and a thermometer, to which Emulsified Slurry 1 (100 parts) was placed, Resin Dispersion Liquid 1 (5 parts) was added and mixed under stirring for 10 min. The mixture was increased in temperature to 60° C. and further stirred for 60 min to obtain Composite Particle Slurry 1.

### Desolvation Step

A container equipped with a stirrer and a thermometer was charged with Composite Particle Slurry 1, and the solvent was removed at 30° C. for 8 hours, to thereby obtain Dispersion Slurry 1.

### Washing and Drying Step

Dispersion slurry 1 (100 parts) was filtrated under reduced pressure and then

(1): ion-exchanged water (100 parts) was added to the filtration cake, and the mixture was mixed with TK Homomixer (at 12,000 rpm for 10 minutes), followed by filtration.

(2): ion-exchanged water (900 parts) was added to the filtration cake obtained in (1), and the mixture was mixed by applying ultrasonic wave vibrations by means of TK Homomixer (at 12,000 rpm for 30 minutes) followed by filtration under reduced pressure. This operation was repeated until the electric conductivity of the reslurry became 10 μC/cm or lower.

(3): 10% hydrochloric acid was added to the reslurry obtained in (2) to adjust the pH to 4, and the resultant was stirred by means of a three-one motor for 30 minutes, followed by subjected to filtration.

(4): Ion-exchanged water (100 parts) was added to the filtration cake obtained in (3), and the mixture was mixed by means of TK Homomixer (at 12,000 rpm for 10 minutes), followed by subjected to filtration. This operation was repeated until the electric conductivity of the reslurry became 10 μC/cm or lower, to thereby obtain Filtration Cake 1.

Next, Filtration Cake 1 was dried with an air-circulating drier for 48 hours at 45° C., and was then passed through a sieve with a mesh size of 75 μm, to thereby obtain Toner Base Particles 1. Toner Base Particles 1 was found to have a volume average particle diameter, Dv, of 7.1 μm, a number average particle diameter, Dp, of 6.3 μm, a Dv/Dp of 1.13 and an average sphericity of 0.978. To the obtained base toner particles (100 parts), 1.0 part of hydrophobic silica was added and mixed by means of HENSCHEL MIXER to thereby obtain Toner 1. FIG. 7 shows an appearance of the obtained Toner 1, which image was obtained with a scanning electron microscope.

### Example 2

Toner 2 of Example 2 was obtained in the same manner as in Example 1, except that Resin Dispersion Liquid 1 in the protrusion formation step was changed to Resin Dispersion Liquid 2.

### Example 3

Toner 3 of Example 3 was obtained in the same manner as in Example 1, except that Resin Dispersion Liquid 1 in the protrusion formation step was changed to Resin Dispersion Liquid 3.

### Example 4

Toner 4 of Example 4 was obtained in the same manner as in Example 1, except that Resin Dispersion Liquid 1 in the protrusion formation step was changed to Resin Dispersion Liquid 4.

### Example 5

### Preparation of Aqueous Phase

Ion-exchange water (970 parts), 29 parts of 25% by mass aqueous dispersion liquid of organic resin particles for stabilizing dispersion (a copolymer of styrene-methacrylic acid-butyl acrylate-sodium salt of methacrylic acid ethylene oxide adduct sulfuric acid ester), 95 parts of 48.5% aqueous solution of sodium dodecyl diphenyl ether disulfonate and 98 parts of ethyl acetate were mixed together under stirring. The resultant mixture had a pH of 6.2. pH was adjusted to 9.1 by adding 10% aqueous solution of sodium hydroxide dropwise to the mixture, whereby Aqueous Phase 2 was obtained.

### Preparation of Pigment/Wax Dispersion Liquid

### Oil Phase

A container to which a stirring rod and a thermometer had been set was charged with Polyester 1 (175 parts), Polyester 2 (430 parts), paraffin wax (HNP9, product of NIPPON SEIRO CO., Ltd.) (153 parts) and ethyl acetate (1,450 parts). The mixture was increased in temperature to 80° C. under stirring, maintained at 80° C. for 5 hours, and cooled to 30° C. for 1 hour. Then, the container was charged with Masterbatch 1 (410 parts) and ethyl acetate (100 parts), followed by mixing for 1 hour, to thereby obtain Raw Material Solution 2.

Raw Material Solution 2 (1,500 parts) was placed in a container, where the pigment and the wax were dispersed with a bead mill (“ULTRA VISCOMILL,” product of AIMEX CO., Ltd.) under the following conditions: a liquid feed rate of 1 kg/hr, disc circumferential velocity of 6 m/s, zirconia beads of 0.5 mm in diameter packed to 80% by volume, and 3 passes. Next, a 70% by mass ethyl acetate solution of Polyester 1 (470 parts) and a 55% by mass ethyl acetate solution of Polyester 2 (250 parts), and ethyl acetate (95 parts) were added thereto, and passed once with the bead mill under the above conditions, to thereby obtain Pigment/Wax Dispersion Liquid 2. Through measurement, the solid content of Pigment/Wax Dispersion Liquid 2 obtained was found to be 49.3% by mass, and the amount of ethyl acetate in the solid content was found to be 103% by mass.

### Emulsifying Step

Pigment/Wax Dispersion Liquid 2 (976 parts) was mixed for 1 min at 5,000 rpm with a TK homomixer (product of Tokushu Kika Kogyo Co., Ltd.). Then, Aqueous Phase 2 (1,200 parts) was added to the mixture. The resultant mixture was mixed for 2 minutes with a TK homomixer while adjusting the rotation speed to from 8,000 rpm to 15,000 rpm to thereby obtain Emulsified Slurry 2.

### Protrusion Formation Step

To a container equipped with a stirrer and a thermometer, to which Emulsified Slurry 2 (100 parts) was placed, Resin Dispersion Liquid 1 (20 parts) was added and mixed under stirring for 10 min. The mixture was increased in temperature to 60° C. and further stirred for 60 min to obtain Composite Particle Slurry 2.

### Desolvation and Washing/Drying

Toner 5 of Example 5 was obtained in the same manner as in Example 1, except that Composite Particle Slurry 1 was changed to Composite Particle Slurry 2.

### Example 6

Toner 6 of Example 6 was obtained in the same manner as in Example 1, except that Resin Dispersion Liquid 1 in the protrusion formation step was changed to Resin Dispersion Liquid 8.

### Example 7

Toner 7 of Example 7 was obtained in the same manner as in Example 1, except that Resin Dispersion Liquid 1 in the protrusion formation step was changed to Resin Dispersion Liquid 9.

### Comparative Example 1

Toner 8 of Comparative Example 1 was obtained in the same manner as in Example 1, except that Resin Dispersion Liquid 1 in the protrusion formation step was changed to Resin Dispersion Liquid 5.

### Comparative Example 2

Toner 9 of Comparative Example 2 was obtained in the same manner as in Example 1, except that Resin Dispersion Liquid 1 in the protrusion formation step was changed to Resin Dispersion Liquid 6.

### Comparative Example 3

Toner 10 of Comparative Example 3 was obtained in the same manner as in Example 1, except that Resin Dispersion Liquid 1 in the protrusion formation step was changed to Resin Dispersion Liquid 7.

### Comparative Example 4

Toner 11 of Comparative Example 4 was obtained in the same manner as in Example 1, except that the protrusion formation step was not carried out.

### Comparative Example 5

Toner 12 of Comparative Example 5 was obtained in the same manner as in Example 1, except that the amount of Resin Dispersion Liquid 1 in the protrusion formation step was changed to 25 parts.

The values of the properties of each toner of Examples and Comparative Examples are shown in Table 1.

TABLE 1

| | | Toner base particles | | | | | | | | | |
|---|---|---|---|---|---|---|---|---|---|---|---|
| | | Average | Average | | | | | | | | |
| | | particle | particle | | | | | | | | |
| | | diameter | diameter | | | Toner | resin | Protrusions | | | |
| | | Dv | Dp | | | Tg1 | particles | Long side | Standard | Coverage | Tg2 |
| | Toner | (μm) | (μm) | Dv/Dp | Sphericity | (° C.) | % by mass | length (μm) | deviation | rate (%) | (° C.) |
| Ex. 1 | Toner 1 | 7.1 | 6.3 | 1.13 | 0.978 | 63 | 5.0% | 0.23 | 0.10 | 48 | 78 |
| Ex. 2 | Toner 2 | 7.2 | 6.5 | 1.11 | 0.971 | 63 | 5.0% | 0.38 | 0.15 | 54 | 81 |
| Ex. 3 | Toner 3 | 7.0 | 6.1 | 1.15 | 0.980 | 63 | 5.0% | 0.20 | 0.09 | 38 | 75 |
| Ex. 4 | Toner 4 | 7.1 | 6.2 | 1.15 | 0.979 | 60 | 5.0% | 0.22 | 0.11 | 45 | 72 |
| Ex. 5 | Toner 5 | 6.9 | 6.3 | 1.10 | 0.974 | 61 | 5.0% | 0.25 | 0.11 | 42 | 78 |
| Ex. 6 | Toner 6 | 7.2 | 6.5 | 1.11 | 0.968 | 63 | 5.0% | 0.32 | 0.14 | 45 | 77 |
| Ex. 7 | Toner 7 | 7.0 | 6.1 | 1.15 | 0.980 | 60 | 5.0% | 0.23 | 0.10 | 56 | 78 |
| Com. Ex. 1 | Toner 8 | 7.1 | 6.4 | 1.11 | 0.966 | 65 | 5.0% | 0.42 | 0.19 | 42 | 83 |
| Com. Ex. 2 | Toner 9 | 6.8 | 5.9 | 1.15 | 0.980 | 58 | 5.0% | 0.48 | 0.24 | 28 | 62 |
| Com. Ex. 3 | Toner 10 | 7.0 | 6.2 | 1.13 | 0.978 | 62 | 5.0% | 0.35 | 0.14 | 52 | 68 |
| Com. Ex. 4 | Toner 11 | 6.8 | 5.9 | 1.15 | 0.976 | 60 | — | — | — | — | — |
| Com. Ex. 5 | Toner 12 | 7.2 | 6.3 | 1.14 | 0.970 | 63 | 25.0% | 0.62 | 0.22 | 72 | 78 |

The above-obtained toners were evaluated by the below-described methods.

### Evaluation of Anti-Stress Property

A predetermined print pattern with a B/W ratio of 6% had been continuously printed onto 1,000 sheets in an H/H (high-temperature and high-humidity) environment, i.e., at 27° C. and 80% RH, using an image forming apparatus (IPSiO SP C220, manufactured by Ricoh Company, Ltd.) set in monochrome mode. The number of fixed streak on the regulating blade was examined and evaluated based on the following criteria. Note that the evaluation “B” or better, i.e., A or B is the level at which there is no problem in practical use.

### [Evaluation Criteria]

A: 0 streak
B: 5 or less streaks
C: 6 to 10 streaks
D: 11 or more streaks

### Background Smear

A predetermined print pattern with a B/W ratio of 6% had been continuously printed onto 2,000 sheets in an N/N (normal-temperature and normal-humidity) environment, i.e., at 23° C. and 50% RH, using an image forming apparatus (IPSiO SP C220, manufactured by Ricoh Company, Ltd.) set in monochrome mode. The background smear on the photoconductor was evaluated as follows. After development, colorless and transparent tape was attached to the uncleaned parts and the toner deposited and causing the background smear on the photoconductor was peeled off and attached to white paper. Then, the density was examined with eyes and evaluated based on the following criteria. All evaluations were carried out based on the following three levels.

### [Evaluation Criteria]

### A: Good

B: Non-problematic in practical use
C: Not acceptable in practical use

### Fixability

The toner was placed in the remodeled image forming apparatus (IPSiO SP C220, manufactured by Ricoh Company, Ltd.), and the copier was set so that the amount of the toner added onto My Recycle Paper, 100 T-Type paper, produced by Ricoh Company Ltd. was 11 g/m², and 19 sheets of 50 mm square unfixed solid print image were prepared.

Next, using the remodeled fixing unit, the system speed was set to 180 mm/sec, the unfixed solid image prepared as above was passed to fix the image on paper. The fixing test was performed while varying the fixing temperature from 120° C. to 200° C. in increments of 10° C. The paper was folded with the fixed images inside and the paper was unfolded. Then, the paper was rubbed lightly with an eraser. A minimum temperature at which a fold line was not erased was regarded as a minimum fixing temperature.

### [Evaluation Criteria]

A: The minimum fixing temperature was lower than 130° C.
B: The minimum fixing temperature was 130° C. or higher but lower than 140° C.
C: The minimum fixing temperature was 140° C. or higher but lower than 150° C.
D: The minimum fixing temperature was 150° C. or higher.

### Evaluation of Fixability and Separability

The toner was placed in the remodeled image forming apparatus (IPSiO SP C220, manufactured by Ricoh Company, Ltd.), and unfixed images were produced by feeding A4-size paper from its short edge side, and printing a belt-like solid image having an edge length of 3 mm and a width of 36 mm (the deposition amount was 9 g/m²) on the paper. This unfixed image was fixed using a fixing device, in the temperature range of 130° C. to 190° C., with the temperature being changed at a rate of 10° C. In this way, separable/non-offset temperature range was determined. The aforementioned temperature range is a fixing temperature range where paper is separated smoothly from the heating roller of the fixing device and offset is not caused and the image does not peel easily. As for the paper used and the paper feeding direction, short-grain paper (45 g/m²) with short edge side feeding paper was used, which would easily become troublesome in terms of separability, and the circumferential speed of the fixing device was set at 120 mm/sec.

### [Evaluation Criteria]

A: The separable/non-offset temperature range was 50° C. or higher.
B: The separable/non-offset temperature range was 30° C. or higher but lower than 50° C.
C: The separable/non-offset temperature range was lower than 30° C.

The results of the evaluation of each developer (toner) of Examples and Comparative Examples are shown in Table 2.

TABLE 2

| | Toner | | | | Evaluation results | | | |
|---|---|---|---|---|---|---|---|---|
| | | | Protrusions | | Development | | Fixing | |
| | Elongation | Presence of | | S monomer | Background | Stress | Lower limit of | |
| | reaction | protrusion | St ratio | ratio | smear | resistance | fixing | Separability |
| Ex. 1 | Yes | Yes | 95% | 3.0% | A | A | A | A |
| Ex. 2 | Yes | Yes | 95% | 0.5% | B | A | B | B |
| Ex. 3 | Yes | Yes | 95% | 5.0% | A | B | B | A |
| Ex. 4 | Yes | Yes | 90% | 3.0% | A | B | A | A |
| Ex. 5 | No | Yes | 95% | 3.0% | A | A | A | A |
| Ex. 6 | Yes | Yes | 95% | 3.0% | A | A | A | A |
| Ex. 7 | Yes | Yes | 95% | 3.0% | B | A | B | B |
| Com. Ex. 1 | Yes | Yes | 100% | 0% | C | A | C | B |
| Com. Ex. 2 | Yes | Yes | 80% | 3.0% | C | D | C | C |
| Com. Ex. 3 | Yes | Yes | 90% | 10.0% | A | D | B | A |
| Com. Ex. 4 | Yes | No | 0% | 0% | C | D | A | B |
| Com. Ex. 5 | Yes | Yes | 95% | 3.0% | C | D | B | B |

In Table 2, “St ratio” and “S monomer ratio” represent a rate of styrene and the monomer having a sulfonic acid group in the resin forming protrusions, respectively.

From the results of Table 2, it was found that the toners of Examples 1 to 7 achieved very satisfactory results over the entire electrophotographic process. In contrast, the toners of Comparative Examples 1 to 5 did not achieve satisfactory results in any of background smear, fixability, .and image quality.

The embodiments of the present invention are as follows.

<1> A toner containing:

toner particles, each toner particle containing a toner base particle,

wherein the toner contains:

a binder resin; and

a colorant,

wherein the toner base particle has protrusions at a surface thereof,

wherein an average of lengths of long sides of the protrusions is 0.1 μm or more but less than 0.5 μm, a standard deviation of the lengths of the long sides of the protrusions is 0.20 or less, and a coverage rate of the protrusions is 30% to 90%,

wherein a resin forming the protrusions is prepared through polymerization of a monomer mixture containing at least a monomer having a sulfonic acid group, and

wherein the monomer mixture contains styrene in an amount of 90% by mass or more and the monomer having a sulfonic acid group in an amount of 0.1% by mass to 5% by mass.

<2> The toner according to <1>, wherein the monomer having a sulfonic acid group is a compound represented by the following General Formula 1:

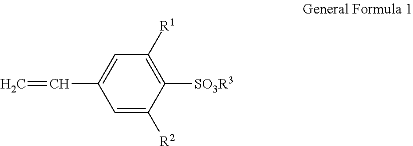

where R¹ and R² each independently represent a substituent selected from a hydrogen atom, an alkyl group, and an alkenyl group; and R³ represents any one of a hydrogen atom, an alkali metal element, an alkyl group, and an alkenyl group.

<3> The toner according to <1> or <2>, wherein the toner has a glass transition temperature Tg1 that satisfies the following Expression 2:

45° C.≦Tg1≦70° C. Expression 2

<4> The toner according to any one of <1> to <3>, wherein the resin forming the protrusions has a glass transition temperature Tg2 that satisfies the following Expression 3:

45° C.≦Tg2≦100° C. Expression 3

<5> The toner according to any one of <1> to <4>, wherein a glass transition temperature of the toner, Tg1, and a glass transition temperature of the resin forming the protrusions, Tg2, satisfy the following Expressions 4 to 6:

50° C.≦Tg1≦65° C. Expression 4

60° C.≦Tg2≦100° C. Expression 5

Tg1<Tg2 Expression 6

<6> The toner according to any one of <1> to <5>, wherein a rate of a mass of the resin forming the protrusions relative to a total mass of the toner is 1% by mass to 20% by mass.
<7> The toner according to any one of <1> to <6>, wherein the toner particles has a volume average particle diameter of 3 μm to 9 μm.
<8> The toner according to any one of <1> to <7>, wherein the toner has a ratio Dv/Dp of 1.25 or less, where Dv is a volume average particle diameter of the toner particles, and Dp is a number average particle diameter of the toner particles.
<9> The toner according to any one of <1> to <8>, wherein the toner particles has an average sphericity of 0.930 or more.
<10> The toner according to any one of <1> to <9>, wherein the toner is a non-magnetic one-component developer.
<11> A developer containing:

the toner according to any one of <1> to <10>.

<12> A toner container containing:

the toner according to any one of <1> to <10>, and

a container, which houses the toner.

<13> A process cartridge containing:

a latent electrostatic image bearing member, a developing unit configured to develop a latent electrostatic image formed on the latent electrostatic image bearing member with the toner according to any one of <1> to <10> to form a visible image.

<14> An image forming apparatus containing:

a latent electrostatic image bearing member;

a latent electrostatic image-forming unit configured to form a latent electrostatic image on the latent electrostatic image bearing member;

a developing unit configured to develop the latent electrostatic image using the toner according to any one of <1> to <10> to form a visible image;

a transfer unit configured to transfer the visible image onto a recording medium; and

a fixing unit configured to fix the transferred image onto the recording medium.

<15> An image forming method containing:

forming a latent electrostatic image on a latent electrostatic image bearing member;

developing the latent electrostatic image using the toner according to any one of <1> to <10> to form a visible image;

transferring the visible image onto a recording medium; and

fixing the transferred image onto the recording medium.

This application claims priority to Japanese application No. 2011-089902, filed on Apr. 14, 2011 and Japanese application No. 2012-068172, filed on Mar. 23, 2012, and incorporated herein by reference.

What is claimed is:

1. A toner comprising:
toner particles, each toner particle containing a toner base particle,
wherein the toner contains:
a binder resin; and
a colorant,
wherein the toner base particle has protrusions at a surface thereof,
wherein an average of lengths of long sides of the protrusions is 0.1 μm or more but less than 0.5 μm, a standard deviation of the lengths of the long sides of the protrusions is 0.20 or less, and a coverage rate of the protrusions is 30% to 90%,
wherein a resin forming the protrusions is prepared through polymerization of a monomer mixture containing at least a monomer having a sulfonic acid group, and
wherein the monomer mixture contains styrene in an amount of 90% by mass or more and the monomer having a sulfonic acid group in an amount of 0.1% by mass to 5% by mass.

2. The toner according to claim 1, wherein the monomer having a sulfonic acid group is a compound represented by the following General Formula 1: 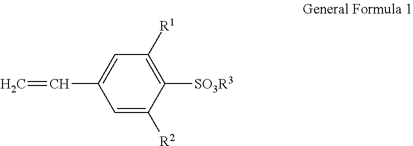
where R¹ and R² each independently represent a substituent selected from a hydrogen atom, an alkyl group, and an alkenyl group; and R³ represents any one of a hydrogen atom, an alkali metal element, an alkyl group, and an alkenyl group.

3. The toner according to claim 1, wherein the toner has a glass transition temperature Tg1 that satisfies the following Expression 2:
45° C.≦Tg1≦70° C. Expression 2

4. The toner according to claim 1, wherein the resin forming the protrusions has a glass transition temperature Tg2 that satisfies the following Expression 3:
45° C.≦Tg2≦100° C. Expression 3

5. The toner according to claim 1, wherein a glass transition temperature of the toner, Tg1, and a glass transition temperature of the resin forming the protrusions, Tg2, satisfy the following Expressions 4 to 6:
50° C.≦Tg1≦65° C. Expression 4
60° C.≦Tg2≦100° C. Expression 5
Tg1<Tg2 Expression 6

6. The toner according to claim 1, wherein a rate of a mass of the resin forming the protrusions relative to a total mass of the toner is 1% by mass to 20% by mass.

7. The toner according to claim 1, wherein the toner particles has a volume average particle diameter of 3 μm to 9 μm.

8. The toner according to claim 1, wherein the toner has a ratio Dv/Dp of 1.25 or less, where Dv is a volume average particle diameter of the toner particles, and Dp is a number average particle diameter of the toner particles.

9. The toner according to claim 1, wherein the toner particles has an average sphericity of 0.930 or more.

10. The toner according to claim 1, wherein the toner is a non-magnetic one-component developer.

11. A process cartridge comprising:
a latent electrostatic image bearing member; and
a developing unit configured to develop a latent electrostatic image formed on the latent electrostatic image bearing member using a toner to form a visible image,
wherein the toner contains toner particles, each toner particle containing a toner base particle,
wherein the toner contains:
a binder resin; and
a colorant,
wherein the toner base particle has protrusions at a surface thereof,
wherein an average of lengths of long sides of the protrusions is 0.1 μm or more but less than 0.5 μm, a standard deviation of the lengths of the long sides of the protrusions is 0.20 or less, and a coverage rate of the protrusions is 30% to 90%,
wherein a resin forming the protrusions is prepared through polymerization of a monomer mixture containing at least a monomer having a sulfonic acid group, and
wherein the monomer mixture contains styrene in an amount of 90% by mass or more and the monomer having a sulfonic acid group in an amount of 0.1% by mass to 5% by mass.

12. An image forming method comprising:
forming a latent electrostatic image on a latent electrostatic image bearing member;
developing the latent electrostatic image using a toner to form a visible image;
transferring the visible image onto a recording medium; and
fixing the transferred image onto the recording medium,
wherein the toner contains toner particles, each toner particle containing a toner base particle,
wherein the toner contains:
a binder resin; and
a colorant,
wherein the toner base particle has protrusions at a surface thereof,
wherein an average of lengths of long sides of the protrusions is 0.1 μm or more but less than 0.5 μm, a standard deviation of the lengths of the long sides of the protrusions is 0.20 or less, and a coverage rate of the protrusions is 30% to 90%,
wherein a resin forming the protrusions is prepared through polymerization of a monomer mixture containing at least a monomer having a sulfonic acid group, and
wherein the monomer mixture contains styrene in an amount of 90% by mass or more and the monomer having a sulfonic acid group in an amount of 0.1% by mass to 5% by mass.
